(19) United States
(12) Patent Application Publication
(10) Pub. No.: US 2005/0243047 A1
(43) Pub. Date: Nov. 3, 2005

(54) Color display device

(75) Inventor: Yasufumi Asao, Atsugi-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/109,757

(22) Filed: Apr. 20, 2005

(30) Foreign Application Priority Data
Apr. 28, 2004 (JP) 134765/2004(PAT.)

(51) Int. Cl. G09G 3/36

(52) U.S. Cl. 345/88

(57) ABSTRACT

One unit pixel is constituted by a subpixel a provided with a red color filter and a subpixel b at which green and blue are displayable in an electrically controlled birefringence (ZCB) mode. The subpixel b is provided with a cyan color filter to increase color purity. As a result, with respect to red, it is possible to effect continuous halftone display. With respect to green and blue, it becomes possible to effect stepwise or continuous halftone display in an areal gradation mode. By the use of the cyan color filter, it is possible to effect green display at a low voltage.

### FIELD OF THE INVENTION AND RELATED ART

The present invention relates to a color display device capable of effecting multi-color display at a high transmittance or a high reflectance and to a color liquid crystal display device and a transflective color liquid crystal display device.

At present, a flat-panel display has widely been popularized as various monitors for a personal computer and the like and as a display device for a cellular phone, and so on. In the future, the flat-panel display is expected to follow popularization more and more, such as development in use for big-screen television.

A most popular flat-panel display is a liquid crystal display. As a color display method for the liquid crystal display, one called a micro-color filter method has been used widely. Other than the liquid crystal display, the micro-color filter method is generally used as the color display method also in so-called electronic paper technology represented by an electrophoretic method.

The micro-color filter method effects full-color display by constituting one unit pixel with at least three subpixels and providing the three subpixels with color filters of three primary colors of red (R), green (G), and blue (B), respectively (hereinafter, appropriately referred to as an “RGC color filter”), thus having an advantage of readily realizing a high color-reproducing performance.

On the other hand, as a disadvantage of the micro-color filter method, a transmittance is ⅓ of a monochromatic display method, so that a light utilization efficiency is low.

This low light utilization efficiency leads to a high power consumption since it is necessary to increase a luminance of a back light or a front light when bright display is intended to be effected in a transmission-type liquid crystal display apparatus having the back light, a transflective (semi-transmission)-type liquid crystal display apparatus having the back light, or a reflection-type liquid crystal display apparatus having the front light.

The low light utilization efficiency is a more serious problem in the case of a reflection-type liquid crystal display device without using the back light. More specifically, a reflection-type color liquid crystal display device provided with the RGB color filter can ensure a sufficient viewability in extremely bright outdoors. On the other hand, however, it is difficult to ensure the sufficient viewability not only in a dark place but also in an environment of brightness in office or home.

On the other hand, as a color liquid crystal display apparatus for effecting color display without using the color filter, an electrically controlled birefringence (ECB)-type liquid crystal display apparatus has been known. The ECB-type liquid crystal display apparatus is constituted by a pair of substrates and liquid crystal sandwiched between the substrates, and is roughly classified into those of a transmission-type and a reflection-type.

In the case of the ECB-type liquid crystal display apparatus of the transmission-type, each of the pair of substrates is provided with a polarization plate. On the other hand, in the case of the ECB-type liquid crystal display apparatus of the reflection-type, there are one-polarization plate type display apparatus in which only one of the substrates is provided with a polarization plate and two-polarization plate type display apparatus in which both of the substrates are provided with a polarization plate and a reflection plate is disposed outside each of the polarization plate.

In the case of the ECB-type liquid crystal display apparatus of the transmission-type, linearly polarized light which comes in through one of the polarization plates is changed into elliptically polarized light consisting of respective wavelength light fluxes different in state of polarization by the action of birefringence of liquid crystal layer in a process of transmitting a liquid crystal cell. The elliptically polarized light enters the other polarization plate and the transmitted light having passed through the other polarization plate is colored light consisting of light fluxes of colors corresponding to light intensities of the respective wavelength light fluxes.

In other words, the ECB-type liquid crystal display device is capable of coloring light by utilizing the birefringence action of the liquid crystal layer of the liquid crystal cell and the polarization action of at least one polarization plate without using the color filter.

As described above, the ECB-type liquid crystal display device causes no light absorption by the color filter, so that it is possible to effect bright color display at a high transmittance of light.

In addition, in the ECB-type liquid crystal display device, the birefringence of the liquid crystal layer is changed by an alignment state of liquid crystal molecules depending on a voltage applied between electrodes of both of the substrates of the liquid crystal cell. In correspondence thereto, the state of polarization of the respective wavelength light fluxes entering the other polarization plate is changed. For this reason, by controlling the voltage applied to the liquid crystal cell, it is possible to change the color of the colored light. In other words, it is possible to display a plurality of colors at one (the same) subpixel.

FIG. 1 is a chromaticity diagram showing an amount of retardation and a corresponding color in the case where the ECB-type liquid crystal display device of the transmission-type is driven in a crossed-Nicol condition. From FIG. 1, it is found that the color is changed depending on an amount of birefringence. In the case where, e.g., the liquid crystal device uses a liquid crystal material having a negative dielectric anisotropy (−Δ∈) such that liquid crystal molecules are vertically aligned to sssume black under no voltage application. With an increase in voltage,the color is changed in the order of black-gray-white-yellow-red-violet-blue-yellow-violet-light blue-green. In a low voltage-side modulation area, a brightness can be changed by a voltage between a maximum brightness and a minimum brightness which constitute an available brightness range of the ECB-type liquid crystal display device. On the other hand, in a high voltage-side modulation area, it is possible to change a (color) hue of the ECB liquid crystal display device to a plurality of available hues by a voltage.

As described above, the liquid crystal display device to a plurality of available hues by a voltage.

As described above, the liquid crystal display device has been conventionally used individually as one of the transmission-type or one of the reflection-type. In recent years, however, such a transflective liquid crystal display device that a part thereof is used as a light-reflective area and another part thereof is used as a light-transmissive area has been widely used in a portable electronic apparatus such as a cellular phone, a personal digital assistant, or the like. Such a portable electronic apparatus can be used both in outdoors and indoors, thus being suitably used since it is an only device having both the advantages of display devices of the transmission-type and of the reflection-type. More specifically, this is because the transflective liquid crystal display device has the advantages that it can ensure a sufficient viewability even in very bright external light in the case where it is used outdoors and that it can ensure high contrast and color reproducibility in the case where it is used indoors.

In SHARP TECHNICAL JOURNAL No. 15 (Whole Number 83) pp. 22-26, August (2002), a cross-sectional constitution of the transflective liquid crystal display device has been described.

According to this journal, in order to maximize both of light utilization efficiencies at a transmission portion and at a reflection portion, an interlayer insulating film is disposed so that a cell thickness at the transmission portion is two times that at the reflection portion.

As the color display method using the ECB effect, Japanese Patent No. 2921589 (Patent Document 1) has proposed that a color reproducibility formed in enhanced by using a red color filter in combination. This is effective means for improving the color reproducibility.

On the other hand, with respect to the reflection-type color liquid crystal display device provided with a current RGB color filter, some electronic paper technologies capable of surpassing it in terms of the viewability have been reported. Most of these technologies are characterized in that bright display can be realized principally without using the polarization plate.

However, the conventional ECB-type liquid crystal display device can only effect display with limited display colors as yet although the conventional ECB-type display method is directed to multi-color display. In addition, although the ECB-type liquid crystal display device is capable of effecting color display on the basis of change in hue utilizing the birefringence effect, it is difficult to effect color display capable of reproducing smooth gradation color and wide color space. As a result, the ECB-type liquid crystal display device can only effect display with a limited number of colors or with a display color poor in color reproducibility, thus providing an insufficient display performance as a display device which values natural picture (image) display, so that it is not generally used presently.

Further, the conventional ECB-type liquid crystal display device requires two polarization plates, so that it is difficult to effect bright display particularly in the case of using the display device as the reflection-type color liquid crystal display device.

On the other hand, as for the electronic paper technologies, there are many reports that bright display can be realized at a monochromatic mode. However, it is difficult to realize multi-color display at a brightness comparable to that of paper under the present circumstances. This is attributable to a lowering in brightness, during the color display, which is ⅓ of that during the monochromatic display as a result of the use of the additive process, as before, such that the RGC micro-color filter is arranged during the color display.

### SUMMARY OF THE INVENTION

An object of the present invention is to provide a color display device having solved the above problems.

According to an aspect of the present invention, there is provided a color display device of the type wherein a display unit is constituted by a plurality of pixels each comprising a first subpixel and a second subpixel, and at each subpixel, a medium for changing an optical property depending on an externally applied voltage is provided,

wherein at the second subpixel, a red color filter is disposed,

wherein the medium changes the optical property within a brightness-changing voltage range in which light passing through the medium changes brightness while assuming achromatic color and a hue-changing voltage range in which the light passing through the medium assumes chromatic color and changes hue of the chromatic color, and

wherein a voltage in the hue-changing voltage range is applied to at least a part of the first subpixel, and a voltage in the brightness-changing voltage range is applied to the second subpixel, thereby to effect color display on a display unit basis.

In the color display device, to the first subpixel, a voltage at which the light passing through the medium assumes blue, green, and their intermediary chromatic color is applied, so that three primary colors are displayed in combination with the the second subpixel.

The first subpixel may preferably be provided with a color filter of a color complementary to the color of the red color filter. To the first subpixel, and a voltage in the hue-changing voltage range is applied to the first subpixel to display a color obtained by color mixing of the chromatic color with the color complementary to the color of the red color filter. As a result, color purity of displayed color is improved.

color display device of the type comprising: at least one polarization plate; a pair of substrates provided with oppositely disposed electrodes; and a liquid crystal layer, disposed between the substrates, for changing a retardation depending on a voltage applied between the electrodes, wherein a display unit is constituted by a plurality of pixels each comprising a first subpixel and a second subpixel;

wherein at the second subpixel, a red color filter is disposed,

wherein the liquid crystal changes the optical property within a brightness-changing voltage range in which light passing through the liquid crystal changes brightness while assuming achromatic color and a hue-changing voltage range in which the light passing through the medium assumes chromatic color and changes hue of the chromatic color, and

wherein a voltage in the hue-changing voltage range is applied to at least a part of the first subpixel, and a voltage in the brightness-changing voltage range is applied to the second subpixel, thereby to effect color display on a display unit basis.

In the color display device, the first subpixel may preferably be provided with a color filter of a color complementary to the color of the red color filter. To the first subpixel, and a voltage in the hue-changing voltage range is applied to the first subpixel to display a color, with high color purity, obtained by color mixing of the chromatic color with the color complementary to the color of the red color filter.

In a preferred embodiment, to the first subpixel provided with the above described color filter, a voltage providing a retardation of approximately 750 nm is applied, thus effecting display of green. In this regard, when the color filter is not used, green with high color purity cannot be displayed only by increasing the retardation up to 1300 nm. In the present invention, however, by use of the color filter, green can be displayed even at a smaller retardation and the display device can be driven at a low drive voltage.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a chromaticity diagram showing a change in chromaticity when an amount of retardation is changed.

FIGS. 2(a) and 2(b) are views each showing a pixel structure of one pixel of the color display device according to the present invention.

FIG. 3 is a chromaticity diagram showing a change in chromaticity when an amount of retardation is changed in the case of providing a color filter of color complementary to a color of a red color filter.

FIG. 4 is an explanatory view of a layer structure used in the color display device of the present invention.

FIGS. 5(a) and 5(b) are explanatory views for illustrating alignment division of the color display device of the present invention.

FIG. 6 is a spectrum diagram of a cyan color filter used in Examples of the present invention.

FIGS. 7, 8 and 9 are views each showing an embodiment of pixel structure of the color display device of the present invention.

FIG. 10 is a schematic view showing a full-color pixel range.

FIGS. 11 to 16 are explanatory views each for illustrating display colors, in a green-blue plane, displayable by a constitution of the color display device of the present invention.

FIGS. 17 to 20 are views each showing an embodiment of the pixel structure of transflective color display device as the color display device of the present invention.

### DETAILED DESCRIPTION OF THE PREFERRED EMBODIMENTS

In the following description, terms with respect to pixel(s) (pixel group) are defined as follows.

First, in an ordinary liquid crystal display device, full-color display is effected by independently controlling three subpixel of red, blue, and green. A minimum unit for effecting such information display is referred to as a “unit pixel”.

An element group which constitutes the unit pixel and has a similar function is referred to as a “pixel”. More specifically, the unit pixel is constituted by a red subpixel, a green subpixel, and a blue subpixel. In the case where the pixel is constituted by some minimum constitutional elements, each of the elements is referred to as a “subpixel”. In the present invention, subpixels (subpixel group) having a common function of capable of utilizing, e.g., a hue-changing voltage range are referred to as a pixel as a whole.

Incidentally, in the present invention, e.g., when a first pixel is divided into subpixels, pixels to which a voltage is applied so as to provide always the same display state are inclusively referred to as one subpixel.

For example, in the case of adopting a constitution as described in U.S. Pat. No. 5,124,695, it is possible to realize 2^{N} gradation levels by effecting pixel division at a predetermined areal ratio described therein. In this case, however, in order to suppress a deviation of barycenter for each gradation level, each of resultant subpixels is further minutely divided into sub-subpixels, which are arranged appropriately. The thus minutely divided sub-subpixels are driven on a subpixel unit basis consisting of a block of the sub-subpixels as a whole. In this constitution, each of the sub-subpixel as a whole. In this constitution, each of the sub-subpixels constituting one subpixel has an utterly different areal ratio from other sub-subpixels. However, in an actual drive, the sub-subpixels are driven at the predetermined areal ratio in an areal gradation drive mode. Similarly, in the present invention, when the areal ratio of pixel division is described, pixels to which a voltage is applied so as to provide always the same display state in the actual drive are considered as one block as a whole. In such a state, the areal ratio of pixel division will be described.

1. Basic Embodiment

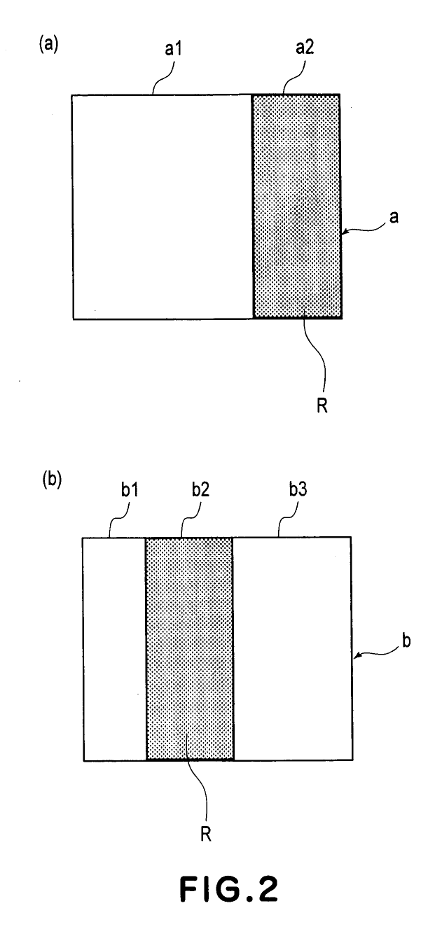

With reference to FIGS. 2 to 9, a color display apparatus to which the present invention is applicable will be described.

(Pixel Structure)

First of all, with reference to FIGS. 2(a) and 2(b), a display principle of the color display apparatus will be described while taking a color liquid crystal display device having an electrically controlled birefringence (ECB) effect as an example.

In a color liquid crystal display device shown in FIG. 2(a), one unit pixel a as a minimum unit for effecting color display is constituted by a plurality (two in this embodiment) of subpixels (hereinafter inclusively referred to as “(sub)pixel(s)”) consisting of a subpixel a2 for displaying red (R) (red subpixel corresponding to a second subpixel) and a subpixel a1 for displaying green (G) and blue (B) (transparent subpixel corresponding to a first subpixel).

Of these two subpixels, the red subpixel a2 shown in FIG. 2(a) is provided with a red color filter but the other subpixel a1 for displaying green and blue is not provided with the color filter. By the constitution, at the red subpixel a2, it is possible to effect not only display of continuous gradation of red but also display of the color of the color filter, so that it becomes possible to effect display of red with high color purity compared with the case of red obtained by interference. On the other hand, at the transparent subpixel a1, a coloring phenomenon by the ECB effect is utilized.

At the red a2, a color reproduction range of red is determined by the color filter R< so that it becomes possible to realize high color reproducibility without sacrificing a transmittance of a white component.

In the present invention, different from the conventionally widely used method, i.e., such a method that three primary colors are displayed by combining the monochromatic display device, which modulates the transmittance by an external modulation means such as a voltage, with the RGB color filter, the ECB-based chromatic colors are utilized, so that, there is no loss of light utilization efficiency which cannot be obviated by the color filter (subpixel division gradation display).

Generally, in the display device utilizing the coloring based on the ECB effect, color display can be effected easily but there has arisen such a problem that it is difficult to effect continuous gradation display.

More specifically, at the red subpixel a2 shown in FIG. 2(a), it is possible to effect the continuous gradation display. However, at the transparent subpixel a1 utilizing the coloring phenomenon by the ECB effect, it is difficult to effect the continuous gradation display. For this reason, in the present invention, e.g., such a constitution shown in FIG. 2(b) is employed. As a result, digital gradation display can be realized by dividing the subpixel a1 shown in FIG. 2(a) into two portions. More specifically, as shown in FIG. 2(b), the transparent subpixel a1 shown in FIG. 2(a) is divided into two subpixels b1 and b3. A subpixel b2 shown in FIG. 2(b) corresponds to the red subpixel a2 shown in FIG. 2(a).

In the case where there are N subpixels, it is possible to obtain a gradation display characteristic with high linearlity by dividing the N subpixels into a plurality of portions of at an areal ratio of 1:2: . . . :2^{N-1}. Incidentally, in the embodiment shown in FIG. 2(b), N=2. In other words, the areal ratio of polarization plates b1:b3 is 1:2. By the combination of the subpixels b1 to b3 shown in FIG. 2(b), four gradation levels of 0, 1, 2 and 3 can be displayed. As in this embodiment, in order to provide a sufficient gradation characteristic with limited gradation levels, a pixel pitch may preferably be small. More specifically, from the viewpoint of such a resolution that a human cannot recognize the pixel, the pixel pitch may preferably be not more than 200 μm.

(Complementary Color Filter)

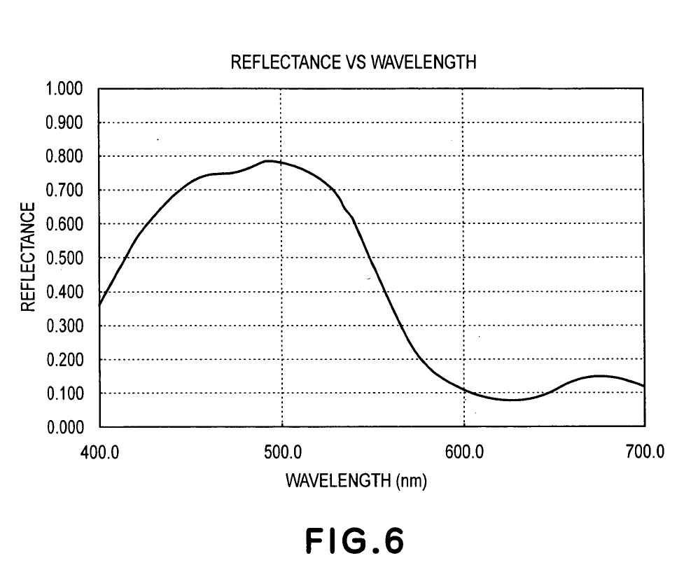

A color filter having a wavelength spectrum (e.g., cyan which is complementary to red) as shown in FIG. 6 is disposed at the above described transparent subpixel (a1 shown in FIG. 2(a); b1 and b2 shown in FIG. 2(b)), whereby color purity of green can be improved to considerably extend the color reproduction range. As a result, the color reproduction range of green is considerably extended, so that it is possible to provide a high-quality display device.

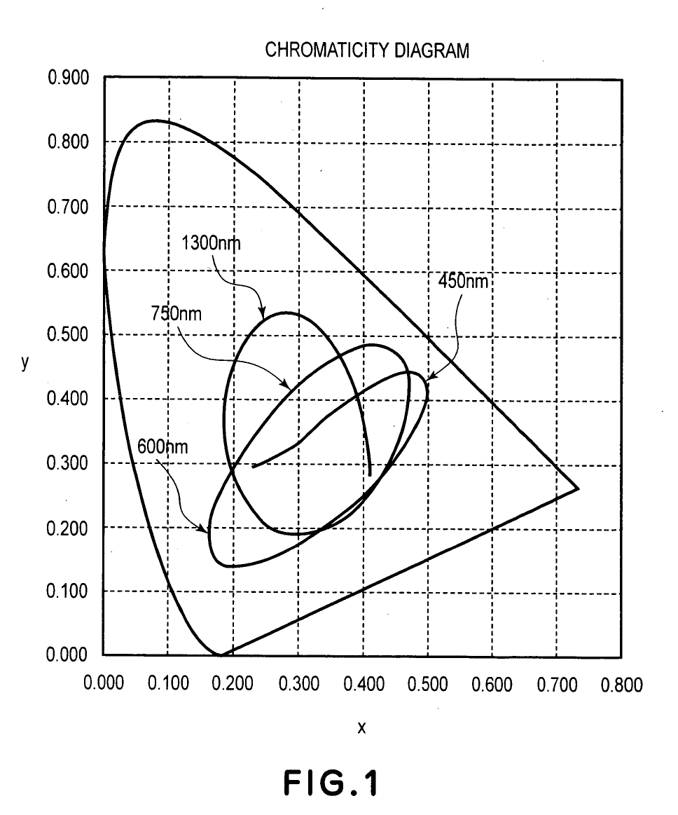

As shown in FIG. 1, when green is displayed with respect to the display color only based on the ECB effect, a retardation of 1300 nm is required in order to display green with high color reproducibility. There is also possibility that green is displayed since green with low color purity is obtained even at a retardation of 750 nm. However, as a display apparatus, the uses thereof are restricted.

In the present invention, by using the color filter of color, such as cyan, complementary to red, a displayable color space is considerably enlarged.

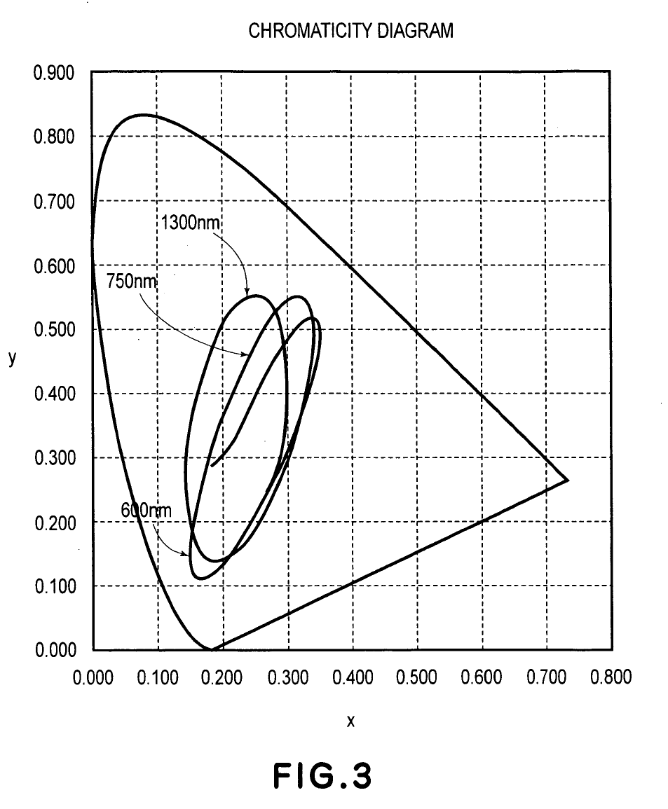

FIG. 1 is such a diagram that the change in hue by the retardation change is shown with no use of the color filter at all. A state of the hue change when an ideal cyan color filter through which light fluxes in a wavelength range of 580-700 nm do not pass but only those in other wavelength ranges pass, is shown in FIG. 3. As shown in FIG. 1, the chromaticity at the retardation of 750 nm is located at a point close to (0.3, 0.4) on the xy chromaticity coordinate and represents whitish green. On the other hand, as shown in FIG. 3, the chromaticity at the retardation of 750 nm is located at a point close to (0.25, 0.45) on the xy chromaticity coordinate, so that it becomes possible to increase the color purity of green even at the same retardation.

In other words, in such a constitution that the color filter is not used at all as shown in FIG. 1, the retardation of 1300 nm is required to represent green at the high color purity. On the other hand, by providing the cyan color filter, it is possible to represent green with sufficient high color purity even at the retardation of 750 nm. As a result, e.g., it becomes possible to suppress a necessary cell thickness to a value which is about ½ of that in the case where the color filter is not used. Accordingly, ease in productivity is advantageously increased.

Further, the color display device of the present invention includes the cyan color filter subpixel and the red color filter subpixel in combination, so that it is possible to effect white display by providing a light transmission state at both of the subpixels at the same time. In addition, by providing a halftone state at both of the subpixels, it is possible to obtain a halftone state for monochromatic display. It is further possible to obtain a black state by providing a light-blocking state at both of the subpixels at the same time.

Further, the point on the xy chromaticity coordinate obtained through the color filter is set so that it is broader than the color reproduction range obtained by interference color on the basis of the ECB effect.

Further, the color display device of the present invention can have such a pixel structure that both of transmittances in the green range and the blue range are high by using the display method utilizing the coloring phenomenon based on the ECB effect and using the color filter of the color complementary to the color of the red color filter.

For this reason, it is possible to considerably decrease light loss compared with the case of using respective color filters of green and blue.

As a result, it is possible to provide a display device with a higher light utilization efficiency than that of the case of such a method that three primary colors are displayed only by the conventional RGB color filter. Accordingly, when the color display device of the present invention is used as the reflection-type liquid crystal display device, the display device can have a high reflection, so that the display method using the display device is a promising display method for paper-like display or electronic paper.

Incidentally, at present, the transmission-type liquid crystal display device having the back light has been widely popularized. This is because the display device is applied to a television, a monitor for a desktop PC (personal computer), or the like. These television and PC are considered that even a current power consumption is at a level of practically no problem. On the basis on the consideration, a high-luminance back light with a relatively high power consumption is used.

On the other hand, as for a reflectance of the reflection-type liquid crystal display device having no light source, even a current reflectance is insufficient, so that there is still room for improvement. For this reason, in the case where the color display device of the present invention is applied to a high-reflectance liquid crystal display device, the display device is a very effective apparatus.

On the other hand, even in the case of using the color display device of the present invention as the transmission-type liquid crystal display device, a transmittance of the liquid crystal layer is high. As a result, a luminance, of the back light, required to provide the same luminance value as in the conventional one may be low. For this reason, the transmission-type liquid crystal display device may suitably be used from the viewpoint of low power consumption of the back light.

Further, in recent years, in the case where the transmission-type liquid crystal display device is used for the television purpose, there has been proposed such a method, called a “pseudo impulse drive”, that a shutoff period of the back light is provided in one frame period in order to realize a crisp motion picture characteristic on the basis of non-hold display. By the method, it is possible to provide a crisper motion picture but there arises such a problem that a lowering in luminance by an amount corresponding to the shutoff period of the back light is caused to occur. In such a television use, a higher luminance is required compared with other uses and on the other kind, the use of such a drive method that a luminance of the back light is insufficient as in the above described pseudo impulse drive is also required. However, for such a purpose, the display device having a high transmittance can be suitably used as in the present invention.

The color display device of the present invention may also be suitably applicable to a projection-type display device requiring a high light utilization efficiency.

2. Modification of Embodiment

In the above described embodiment, analog gradation is realized by the color filter with respect to red display and digital gradation is realized, during display of green and blue, by utilization of the coloring phenomenon based on the ECB effect and the display method based on the pixel division method with respect to green and blue.

On the other hand, in the reflection-type liquid crystal display device as described above, there is also a use requiring a high transmittance and more display colors. Further, in the transmission-type liquid crystal display device capable of effecting full-color display, there have also been a requirement with respect to a high-transmittance display device in order to suppress the power consumption of the back light while retaining a full-color display performance. In addition thereto, there are many requirements with respect to such a display mode capable of effecting full-color display with high light utilization efficiency.

In order to meet the above described requirements, on the basis of the color display device described above, other methods (schemes) capable of effecting multi-color display will be explained.

The methods include the following methods (1), (2) and (3):

(1) a method in which the coloring phenomenon based on the ECB effect is also utilized at a retardation other than those for green and blue,

(2) a method in which continuous gradation color in a low retardation region at the subpixel provided with the color filter of color complementary to red is utilized, and

(3) a method in which a subpixel provided with either one of color filters for green and blue is added.

Method (1)

In the above described embodiment, the principle of effecting the display of green and blue by utilizing the coloring phenomenon on the basis of the ECB effect. In the coloring phenomenon based on the ECB effect, as shown in FIG. 1, it is possible to change the hue continuously from white to green. More specifically, there are many available display colors other than green and blue described above. By using such display colors, it becomes possible to represent display colors larger in number than those described above.

Further, with respect to the resultant chromatic colors, similarly as in the case of green and blue, it becomes possible to represent the digital gradation by the above described constitution. As a result, it is possible to represent many more display colors.

Method (2)

For example, in the case where the color filter of cyan complementary to red is provided at one subpixel (first subpixel), a brightness of the chromatic color is changed in such a manner that a display state is changed from a black display state to a bright cyan display state through a dark cyan display state (intermediary display state of cyan) with an increase in retardation from zero. Thereafter, when the retardation is further increased to such a range that it exceeds a white range in the case of not providing the color filter at the first subpixel, such a continuous change of chromatic color that it is changed in the order of cyan, blue, and green is achieved. For example, in FIG. 3, with respect to the liquid crystal display device having the characteristic shown in FIG. 1, calculated values in the case of disposing such an ideal cyan color filter providing a transmittance of zero in the wavelength range of 580-700 nm and a transmittance of 100% at other wavelengths are shown. By disposing the cyan color filter as described above, it is possible to extend the color reproduction range of green. At the same time, as shown by arrows in FIG. 3, it is possible to confirm a continuous change in chromatic color when the retardation is changed.

In order to represent a change in brightness of achromatic color, gradation information on the above described cyan color filter subpixel and that on the separately provided red color filter subpixel are appropriately controlled simultaneously.

As described above, by using the color filter of cyan or the like complementary to the color of the red color filter, it is possible to effect gradation display of achromatic color and gradation display of the color complementary to red at the same time, so that it is possible to considerably increase the number of display colors.

Method (3)

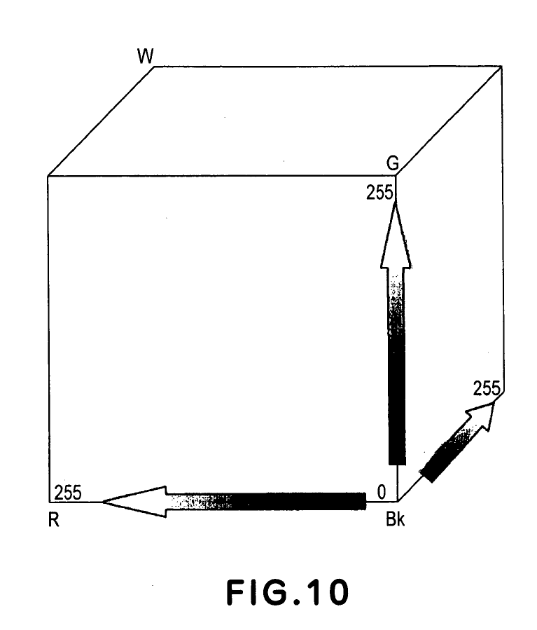

The display color obtained by the above described method (3) will be explained with reference to FIG. 10. An arbitrary point in a cube shown in FIG. 10 represents a display color which is displayable in an additive process. A vertex represented by “Bk” shows a state of a minimum brightness. When image information signals of red (R), green (G) and blue (B) are supplied, a display color corresponding to a position (point) of the sum of independent vectors of R, G and B each extended from the vertex “Bk”. Vertexes “R”, “G” and “B” represent maximum brightness states of red, green and blue, respectively. A vertex “W” represents a white display state at a maximum brightness. A length of one side of the cube is 255 in this embodiment.

In the color display device of the present invention, with respect to red (R), the continuous gradation display is effected by the color filter, so that display color may be located at any point in a red direction. For this reason, in the following description with respect to the display color, the display color in a plane constituted by green and blue vectors (hereinafter referred to as a “GB plane”) is discussed.

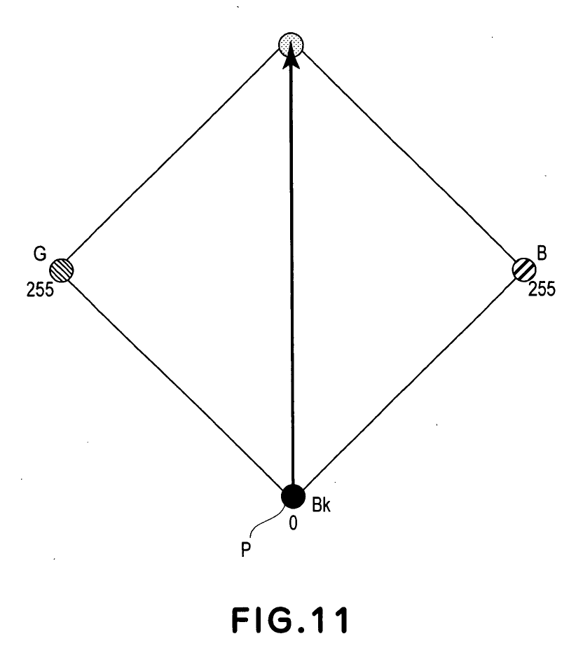

First of all, the case where a subpixel utilizing the coloring phenomenon based on the ECB effect is one (the case of no pixel division) will be described with reference to FIG. 11. FIG. 11 shows a GB plane. During green display and blue display, the coloring phenomenon based on the ECB effect is utilized, so that available states as bright and dark states are two values of “ON” and “OFF”. Accordingly, available points on each of G-axis and a B-axis are two points representing a maximum value and a minimum value. On the other hand, in the method (2), the color filter of cyan complementary to red is provided but the complementary color to red corresponds to color obtained by the additive process of green and blue. Accordingly, the display color described in the method (2) corresponds to that a continuous change in brightness is achieved on an axis indication of a synthetic vector of green and blue. More specifically, in FIG. 11, any point selected from the (original) point “Bk”, the points “G” and “B”, and those on the arrow can be utilized as the display color.

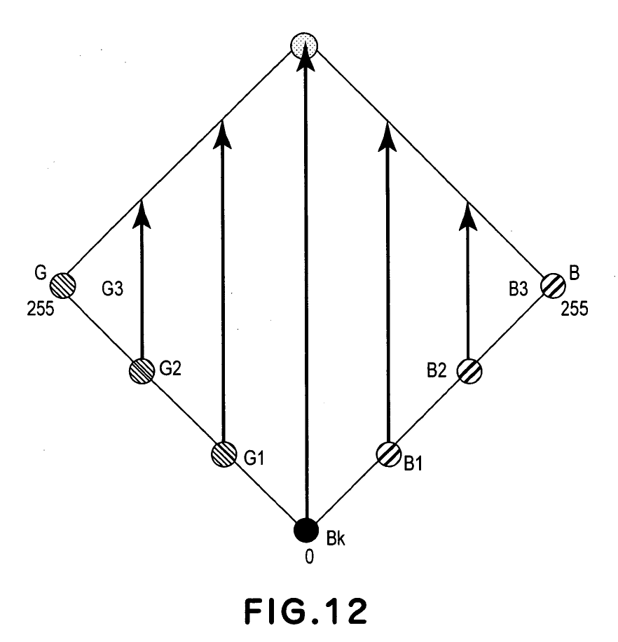

Next, the case where the subpixel utilizing the coloring phenomenon based on the ECB effect is divided into two subpixels in an areal ratio of 1:2 will be described with reference to the GB plane shown in FIG. 12. In this case, similarly as in the case of no pixel division, the coloring phenomenon based on the ECB effect is utilized during the green display and the blue display, so that available dark and bright display states are two values of “ON” and “OFF” for each of the divided pixels. Further, one pixel is divided into two subpixels at the areal ratio of 1:2, so that four points indicated by circles are available on each of the axis-G and the axis-B.

In FIG. 12, at the points G3 and B3, the corresponding two subpixels are placed in the green display state and the blue display state, respectively. At each of the points G1 and B1, the corresponding subpixel which is a smaller subpixel of the divided two subpixels is placed in a blue display state or a green display state, and the remaining larger subpixel is placed in a black display state. The large subpixel can assume continuous gradation color for cyan, so that it can be located at any point on each of the arrows extending from the points G1 and B1 in the GB synthetic vector direction. On a similar principle, it can also be located at any point on each of the arrows extending from the points G2 and B2 in the GB synthetic vector direction.

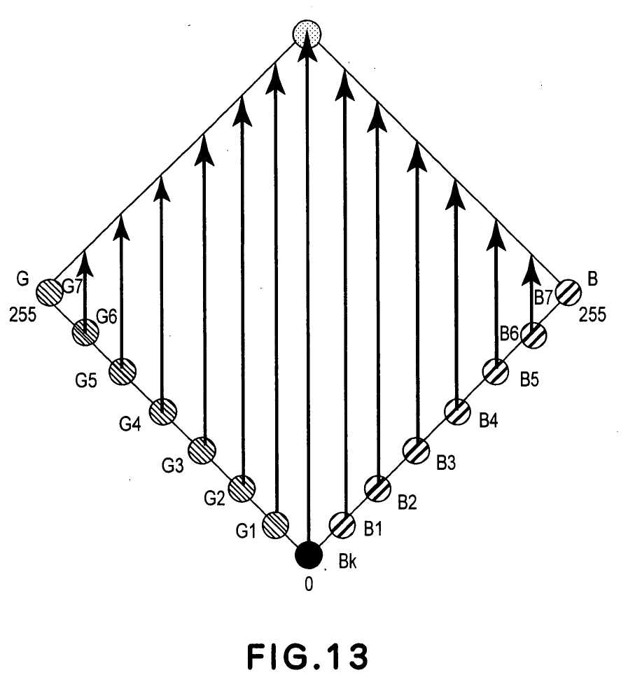

Further, on a similar principle, in the case where the pixel utilizing the coloring phenomenon based on ECB effect is divided into subpixels at an areal ratio of 1:2:4, available display colors are indicated by arrows in FIG. 13.

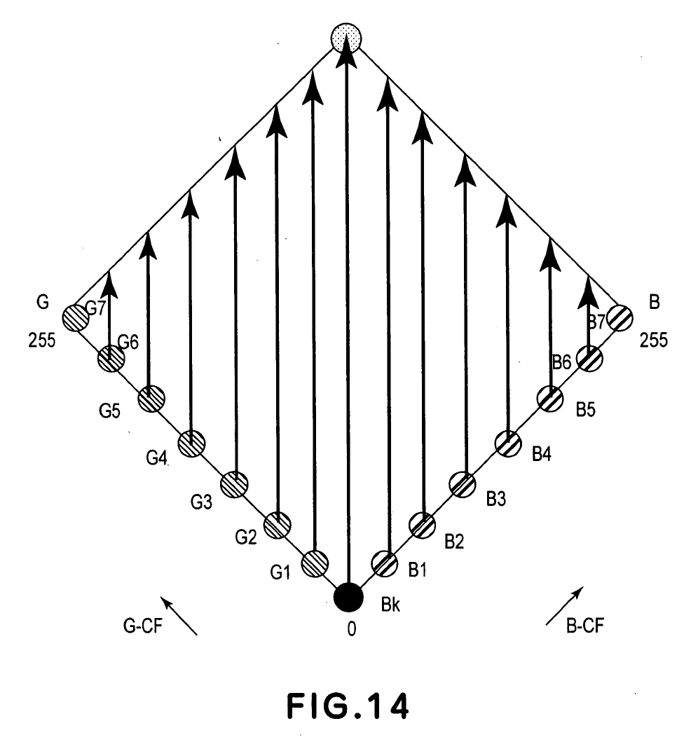

As described above, as the number of divided subpixels is increased, the number of displayable colors in the GB plane is also increased. However, this method is based on the digital gradation, not the analog full-color display method. Accordingly, in order to realize the analog gradation, pixels provided with color filters of green and blue may be added, whereby it is possible to display continuous gradation levels of green and blue. As a result, it becomes possible to complement portions other than the arrows shown in FIGS. 12 and 13, so that it is possible to represent all the points in the GB plane. A size of each of the pixels provided with the color filters of green and blue is sufficient so long as it has an area comparable to that of a minimum-sized subpixel of the above described divided subpixels. More specifically, e.g., in FIG. 13, the displayable points indicated by circles extending from the point “Bk” to the point “G7” and from the point “Bk” to the point “B7” are located at the same spacing. Further, it is possible to utilize any point on the arrows extending from the respective circle points in the GB synthetic vectors. To such a color displayable constitution, the pixels, provided with the color filters of green and blue, each having the same area as the associated minimum-sized subpixel of the pixel-divided subpixels are added, whereby it is possible to effect the additive process at any point in a direction of each of arrows G-CF and B-CF shown in FIG. 14. As a result, it is possible to represent all the points in the GB plane, so that it becomes possible to effect complete analog full-color display.

Further, as described above, the size of the added pixels provided with the green color filter and the blue color filter is sufficient so long as it has the same area as the minimum-sized subpixel of the pixel-divided subpixels. For this reason, as the pixel division number is increased, it is possible to effectively alleviate the influence of a lowering in light utilization efficiency due to the use of the green and blue color filters. In other words, as the number of division of pixel utilizing the coloring phenomenon based on the ECB effect is increased, it becomes possible to realize a higher light utilization efficiency.

Further, by effecting the continuous gradation display of green in the above described manner, it is also possible to achieve an effect of increasing the number of gradation levels of green having a highest luminosity characteristic. For example, in the conventional color display device, i.e., the color display device obtained by the combination of the display device achieving the change in brightness of achromatic color with the RGB color filter, when the brightness change of achromatic color corresponds to, e.g., 256 gradation levels (8 bit gradation levels), 256 gradation levels are present for all the display colors. On the other hand, in the color display device of the present invention, it is possible to provide not only the 8 bit gradation levels obtained by the brightness change of achromatic color but also gradation levels obtained by the area division. More specifically, in the embodiment shown in FIG. 14, 3 bit gradation levels can be obtained by the area division, so that it is possible to obtain 11 bit gradation levels in total with respect to green and blue. As a result, it is possible to effect very smooth natural picture display.

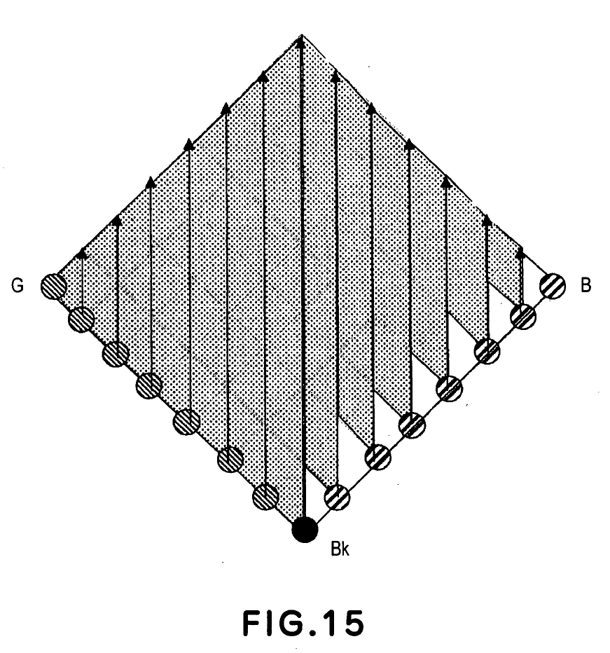

Incidentally, in the above embodiment, it is possible to achieve an effective result even when both of the green color filter and the blue color filter are not necessarily added. More specifically, on the same display principle, in FIG. 15, a displayable color range is indicated by dotted area when only the green color filter is added. In FIG. 15, in the green direction, all the colors are displayable but in the blue direction, there are colors which are not displayable. However, with respect to a human luminosity characteristic, blue is least sensitive, so that the number of necessary gradation levels is considered to be smallest. Accordingly, it is possible to obtain the display colors substantially comparable to full-color levels by adding only the green color filter.

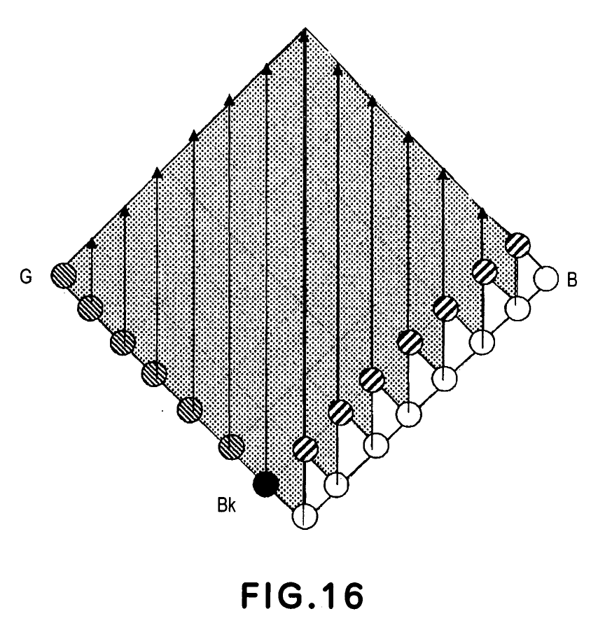

A constitution shown in FIG. 16 is the same as that shown in FIG. 15 except that the referential point “Bk” is shifted to the position of the point “G1” in FIG. 14. As a result, it is possible to represent all the display colors. Incidentally, in this embodiment, the black display state provides a slightly greenish display color but such a method is applicable to the uses in which a contrast of the resultant display device e.g., as in the reflection-type display device is not severely required compared with the transmission-type display device.

By the above described methods, it becomes possible to display the display colors identical or comparable to the full color levels while retaining the high light utilization efficiency.

Incidentally, in the present invention, the display colors based on the change in retardation is utilized, so that a change in hue depending on a viewing angle must be taken into consideration. However, the progress of LCD development in these days is remarkable, so that it is not too much to say that the problem of viewing angle dependency is substantially solved in color liquid crystal display using the RCB color filter method. For example, in an OCB (optically compensated bend) mode, it has been reported that the change in retardation due to the change in viewing angle is suppressed by a self-compensation effect by bend alignment. Further, by the progress of development of a phase-difference film in an STN mode, the viewing angle characteristic is remarkably improved. Also in these OCB and STN modes, it is possible to realize the coloring phenomenon base don the ECB effect by appropriately setting the amount of retardation, so that the constitution of the present invention is applicable thereto. Particularly, in the OCB mode, it is possible to considerably increase the above described response speed, so that in the present intention, the OCB mode is suitably adopted in the use requiring high-speed responsiveness.

On the other hand, an MVA (multidomain vertical alignment) mode has already been commercialized as a mode providing a very good viewing angle characteristic and has been widely used. In addition, a PVA (patterned vertical alignment) mode has also been used widely. In these vertical alignment modes, the wide viewing angle characteristic is realized by providing a surface unevenness (MVA mode) or appropriately shaping an electrode (PVA mode) to control an inclination direction of liquid crystal molecules under voltage application. In these modes, the amount of retardation is changed by the voltage, so that the constitution of the present invention is applicable to the modes.

As described above, in the present invention, it becomes possible to realize the color liquid crystal display device satisfying the higher transmittance (or reflectance), the wide viewing angle, and the broad color space at the same time.

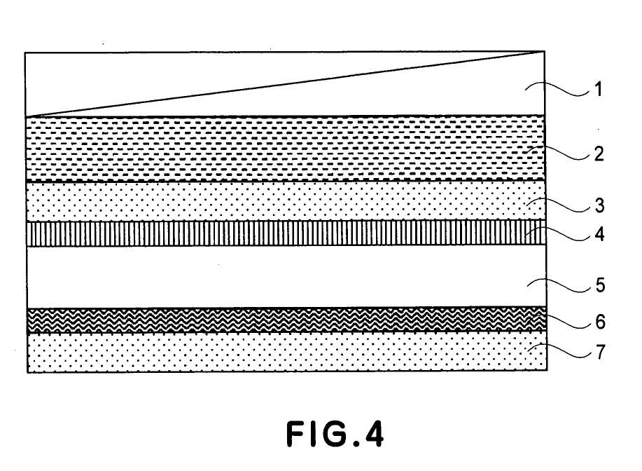

Incidentally, FIG. 4 shows a schematic structure of the reflection-type color liquid crystal display device according to the present invention. As shown in FIG. 4, the reflection-type color liquid crystal display device includes a polarization plate 1, a phase-compensation plate (or film) 2, a glass substrate 3, a transparent electrode 4, a liquid crystal layer 5, a transparent electrode 6, and a glass substrate 7 provided with a surface reflection plate.

A bright/dark display principle of the reflection-type color liquid crystal display device will be briefly described.

For simplicity's sake, a wavelength used in this embodiment is only 550 nm (single wavelength). The phase-compensation plate 2 has a single axis and a retardation of 137.5 nm and is disposed to provide a slow axis forming an angle of 45 degrees with respect to a polarization axis of the polarization plate 1 in a clockwise direction.

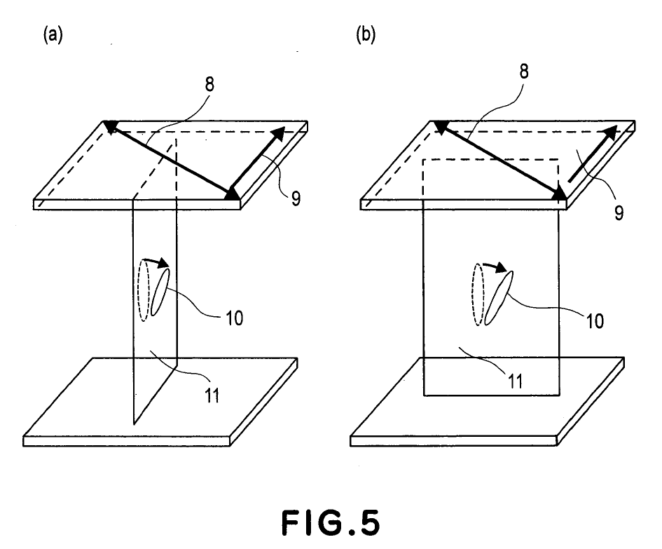

Liquid crystal molecules 10 (shown in FIGS. 5(a) and 5(b)) in the liquid crystal layer 5 are vertically aligned when a voltage is not applied thereto and are inclined when the voltage is applied. In such a VA (vertical alignment) mode, e.g., as shown in FIG. 5(a), the direction of inclination of the liquid crystal molecules 10 is parallel to an optical axis 9 of the phase compensation plate 2, i.e., forms an angle of 45 degrees in a clockwise direction with respect to the polarization plate 1 (when viewed from the polarization axis 8 side). Incidentally, in FIGS. 5(a) and 5(b), a reference numeral 11. represents a rotation plane of the liquid crystal molecules 10.

External light passing through the polarization plate 1 is separated into a polarized light component in the direction of the optical axis 9 of the phase-compensation plate 2 and a polarized light component in a direction perpendicular to the optical axis direction. Each of the light components reciprocally passes through the phase-compensation plate 2 and the liquid crystal layer 5 two times. As a result, a phase difference between the two polarized light components is caused to occur. The phase difference value is given by the sum of a retardation of the phase-compensation plate 2 and a retardation of the liquid crystal layer 5. Then, the light components pass through the polarization plate 1 again to come out of the display device.

In the case where the voltage is not applied to the liquid crystal layer 5, the liquid crystal molecules are vertically aligned, so that the retardation of the liquid crystal layer 5 is zero. Accordingly, a reflectance T (%) in the above described constitution is represented by the following equation:
T(%)=cos²(π×2×137.5/500)=0.

As a result, the reflectance under no voltage application is zero, so that the constitution is a normally black constitution.

Next, the time of applying the voltage is considered.

When the liquid crystal layer 5 is supplied with the voltage, the liquid crystal molecules 10 are inclined in a direction in parallel with the phase-compensation plate 2. Accordingly, when a retardation generated in the liquid crystal layer 5 by the inclination of the liquid crystal molecules 10 is R (V), a reflectance T (V) (%) represented by the following equation:
T(V)(%)=cos²(π×2×(137.5+R(V))/500).

As a result, a desired reflectance depending on the voltage is attained.

In the above description, the liquid crystal molecules 10 are inclined in parallel with the optical axis direction of the phase-compensation plate 2. The light passing through the phase-compensation plate 2 is circularly polarized light, so that the inclination direction of the liquid crystal molecules 10 is not limited to the above direction but may be an arbitrary direction.

As the alignment mode in which the liquid crystal molecules are placed in the vertical alignment state similarly as described above, a CPA (continuous pinwheel alignment) mode has been proposed by SHARP TECHNICAL JOURNAL No. 12 (Whole Number 80), pp. 11-14, August (2001).

According to this technical journal, similarly as in the above described PVA mode, the CPA mode is also a mode in which the liquid crystal molecule inclination direction under voltage application is controlled by appropriately shaping the electrode. In the CPA mode, at the time of applying the voltage, the liquid crystal molecules are placed in such an alignment state that they are inclined radially from a center portion of subpixel to realize a wide viewing angle. Also in the CPA mode, the retardation is changed by the voltage, so that the constitution of the present invention is applicable thereto.

In the above described technical journal (No. 12), there is such a description that it is possible to utilize birefringence and optical rotatory power in combination by using a reverse TN mode in which a liquid crystal material to which a chiral agent (dopant) is added in order to enhance a transmittance of liquid crystal, so that a light utilization efficiency is increased. The addition of the chiral agent is also applicable to the constitution of the present invention.

However, in the case where the display device is the reflection-type liquid crystal display device and uses a circular polarization plate in the constitution of the present invention, it is possible to obtain a good reflectance in the CPA mode without adding the chiral agent.

More specifically, such a constitution having a lamination structure of three layers consisting of a circular polarization plate, a liquid crystal layer, and a reflection plate will be considered.

In the case where there is no birefringence in the liquid crystal layer, e.g., the liquid crystal layer is in the vertical alignment state, externally incident light first passes through the circular polarization plate and is reflected without being modulated in a polarized light state. The reflected light passes through the circular polarization plate again to travel toward the outside of the display device. Thus, the light passes through the circular polarization plate two times, so that the light comes out of the display device particularly in such a wavelength region satisfying a circular polarization condition. In other words, in the CPA mode in which the liquid crystal molecules are vertically aligned in the no voltage application state, the above described constitution is the normally black constitution.

When the voltage is applied, the liquid crystal molecules are inclined radially, so that the liquid crystal molecules are inclined in all the directions with respect to an azimuth angle direction. In the case where the display device is the transmission-type and linearly polarized light enters the liquid crystal layer as in the above described technical journal (No. 12), the light utilization efficiency is lowered when a molecular axis direction of the liquid crystal is aligned with the polarization direction. However, in the case of such a constitution that the circularly polarized light enters the liquid crystal layer, the polarized light is uniformly modulated irrespective of the molecular axis direction in which the liquid crystal molecules are inclined. On the above described principle, in the case where the reflection-type display mode using the circular polarization plate and the CPA mode are applied to the constitution of the present invention, the chiral agent may be added as described in the technical journal (No. 12) and may not be necessarily added.

Incidentally, as described above, a late liquid crystal display device advances toward a wider viewing angle. In the mode of this embodiment, however, the viewing angle is considered that it is somewhat narrower than that in the above described known modes.

However, with respect to this problem, it becomes possible to obviate the viewing angle problem by substantially restricting the direction of light from a light source to a direction normal to the substrate in the transmission-type mode or the projection-type mode. More specifically, in the transmission-type liquid crystal display device, light from the back light is collimated so as to provide parallel light and is caused to diffuse after passing through the liquid crystal layer, so that it is possible to realize such a constitution that the change in hue is not caused to occur even when the display device is viewed from any direction. Further, in the case of the projection-type liquid crystal display device, the light generally enters the display device from the substrate normal direction, so that it can be said that there is no problem of viewing angle.

3. Transflective-Type Liquid Crystal Display Device

With respect to a cross-sectional constitution of the above described transflective liquid crystal display device, such a constitution that an interlayer insulating film is provided so that a cell thickness at a transmission portion is two times that a reflection portion in order to maximize the light utilization efficiency at both the transmission portion and the reflection portion has been known.

This constitution may also be adopted in the color display device of the present invention.

On the other hand, however, in the case where the above constitution is to be realized in the color display device of the present invention, the color display device requires a larger cell thickness than an ordinary liquid crystal display device since it is based on the display principle utilizing coloring on the basis of birefringence. In other words, the above described interlayer insulating film is required to have a larger thickness than an ordinary transflective-type liquid crystal display device.

When the state of use of the transflective-type liquid crystal display device is taken into consideration, as described hereinabove, the display device requires that display is effected with sufficient viewability even in a condition of very bright external light and that a high contrast and a high color reproducibility are realized in doors or in a dark place, thus faithfully reproducing full-color digital contents.

Of these requirements, with respect to the display with sufficient viewability even in the condition of very bright external light, it is possible to effect such display by the use of the display method on the basis of the display principle utilizing the birefringence-based coloring phenomenon in the present invention in the reflection-type mode.

On the other hand, in the display method described as the basic constitution in the present invention, the display method utilizing the ECB effect-based coloring phenomenon for display colors, other than red, such as green and blue and the digital gradation by the area division of pixel are adopted. Such a digital gradation level exceeds a human recognition limit in a very high-definition display device, so that a gradation display performance is somewhat insufficient in some cases when the gradation levels correspond to the full-color display levels but are not necessarily sufficient in terms of definition.

Accordingly, in order to faithfully reproduce the full-color digital contents in the transmission-type mode, it is considered that it is necessary to provide a higher gradation display performance.

In the present invention, the generally used micro-color filter method in which the RGB color filter is used in the transmission mode and the liquid crystal layer is continuously changed in transmittance from black to white is adopted. In the reflection mode, green display and blue display are effected by the mode utilizing the ECB effect-based coloring phenomenon and red display is effected by the color filter. On the other hand, in the transmission mode, all the color displays of red, green, and blue are effected by color filters. As a result, the above described two requirements in the transflective-type liquid crystal display device can be compatibly realized.

By adopting such a display constitution that the display modes for reflection and transmission are different from each other, unexpected effective results, not those by a simple combination are achieved.

More specifically, the current transflective liquid crystal display device described above adopts the display method on the basis of the same principle in the reflection area and the transmission area, so that a twice cell thickness different must be given between the reflection area and the transmission area in order to provide an optimum light utilization efficiency each in the reflection and transmission means.

For this reason, as described above, it is necessary to use the interlayer insulating film forming process.

On the other hand, as in the present invention, the case of the transflective-type liquid crystal display device employing different display modes for reflection and transmission, particularly between, as the reflection mode, the mode utilizing the ECB effect-based coloring phenomenon and, as the transmission mode, the mode which does not utilize the ECB effect-based coloring phenomenon is considered.

In the mode utilizing the ECB effect-based coloring phenomenon, realization of display up to green on the basis of the ECB effect is sufficient for the present invention. Accordingly, in order to realize the display from block to blue in the reflection mode, the change in retardation in the range of 0-380 nm by the control of voltage is sufficient for the liquid crystal layer (or the combination of the liquid crystal layer with the phase-compensation plate).

On the other hand, in order to realize the display from black to white in the transmission mode by the ECB effect, the change in retardation in the range of 0-250 nm by the control of voltage is sufficient for the liquid crystal layer (or the combination of the liquid crystal layer with the phase-compensation plate). More specifically, the difference between the cell thickness required in the reflection area and that required in the transmission area is smaller than the two times required in the conventional constitution. Accordingly, compared with the current constitution, it becomes possible to decrease the thickness of the above described interlayer insulating film. As a result, it is possible to suppress alignment defect which is liable to occur due to the provision of the difference in cell thickness and a lowering in aperture ratio due to a tapered stepwise portion.

Further, by limiting the control range of the retardation by the voltage in the transmission mode to 0-250 nm while keeping the liquid crystal layer thickness at a constant level under a condition capable of controlling it up to 380 nm, the above described interlayer insulating film may be omitted. As a result, it is possible to realize a simple photolithographic process to reduce production cost. Further, it is possible to easily realize uniform alignment to improve the aperture ratio.

Incidentally, in the transflective-type liquid crystal display device of the present invention, there is a possibility that display colors displayed in the reflection mode the transmission mode under the same voltage application condition are different from each other.

In this case, it is preferable that the pixel constitution is designed so that an applied voltage can be controlled independently in the reflection area and the transmission area.

As described above, the present invention is applicable to the transflective-type color liquid crystal display device capable of compatibly realizing the reflection mode and the transmission mode each in which multi-color display can be effected with high light utilization efficiency. As a result, it becomes possible to meet such a requirement of high color reproducibility for, e.g., perusing the digital contents. Further, it becomes possible to effect bright color display with respected to various electronic paper technologies capable of realizing bright monochromatic display.

4. Preferable Constitutional Embodiments

On the basis of the above described constitutions, preferred specific embodiments will be described with reference to the drawings.

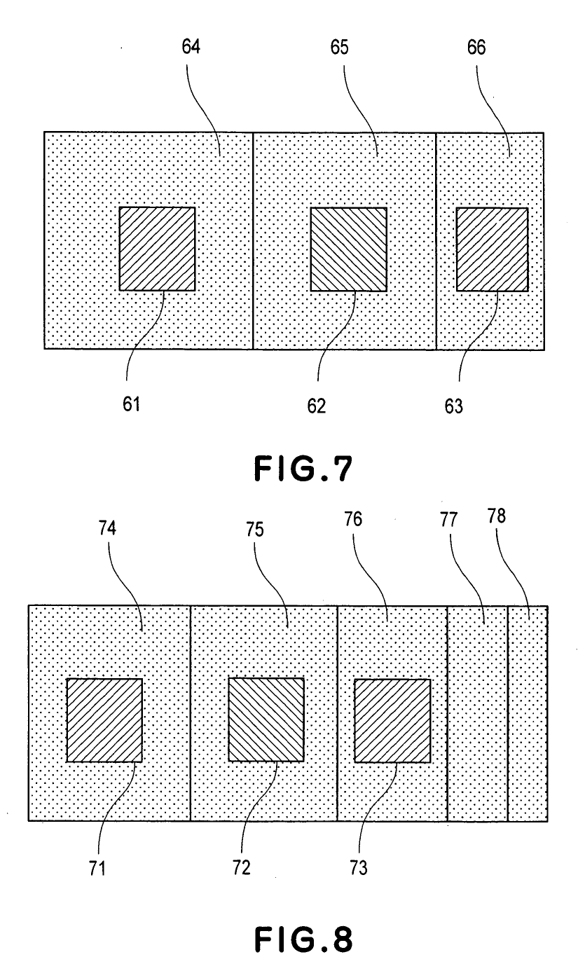

FIG. 7 shows a preferred embodiment of a pixel constitution of the color liquid crystal display device of the present invention.

Referring to FIG. 7, the pixel constitution includes transparent electrodes 61, 62 and 63 of ITO (indium-tin oxide). On each of optical paths of light passing through the transparent electrodes 61, 62 and 63, color filters of red, green and blue are disposed, respectively. The pixel constitution further includes reflection electrodes 64, 65 and 66 of aluminum or the like. On an optical path of light reflected by the reflection electrode 65, the red color filter is disposed. The color filter may be of the reflection-type providing a narrow color reproduction range in order to increase the color utilization efficiency. Alternatively, it is also possible to form a transmission-type color filter for the transparent electrode 62 only at a part of the reflection electrode 65. The color filters on the reflection electrodes 64 and 66 may be omitted or may be those of color, complementary to red, such as cyan, thus increasing a color purity of display color by utilizing the ECB effect-based coloring phenomenon.

The transparent electrodes 61, 62 and 63 may preferably have the same areal ratio, and the reflection electrodes 64 and 66 may preferably have an areal ratio of 2:1. Incidentally, these areal ratios may further preferably be finely adjusted in view of balance of transmittances of the color filters. An areal ratio between a first subpixel 64 and a second subpixel 65 or between a first subpixel 66 and the second subpixel 65 may preferably be appropriately adjusted so as to provide an optimum color balance depending on a wavelength spectrum transmission characteristic of the associated color filter.

When the first subpixel at which the coloring phenomenon on the basis of the ECB effect is utilized is area-divided into a plurality of subpixels, it is preferable that a pixel shape and a pixel configuration are taken into consideration so as not to deviate a color gravity for each gradation level (not shown).

Further, in many cases in the ordinary transflective-type liquid crystal display device, the same voltage is applied to a combination of a transmission pixel and a reflection pixel, such as the transparent electrode 61 and the reflection electrode 64, the transparent electrode 62 and the reflection electrode 65, or the transparent electrode 63 and the reflection electrode 66. However, in the color liquid crystal display device of the present invention, the display condition is different between the reflection mode and the transmission mode, so that these six pixels may preferably be designed so as to be independently voltage-controlled.

Further, it is possible to add smaller subpixels as shown in FIG. 8 in order to increase the number of gradation levels in color display utilizing the ECB effect-based coloring phenomenon in the reflection mode. In FIG. 8, transparent electrodes 71, 72 and 73 and reflection electrodes 74, 75 and 76 correspond to the transparent electrodes 61, 62 and 63 and the reflection electrodes 64, 65 and 66 shown in FIG. 7, respectively. The added smaller subpixels are 77 and 78 and may preferably be arranged so that an areal ratio between the subpixels 78, 77, 76, . . . in the light reflection area is 1:2:4: . . . :2^{N-1}.

The shapes of the electrodes are not limited to those shown in FIG. 8 but may be selected from various electrode shapes.

In the light transmission area, a liquid crystal layer has an analog gradation ability for each of red (R), green (G) and blue (B), so that it is not necessary to increase the number of pixels compared with the constitution shown in FIG. 7.

With respect to the above described transflective-type liquid crystal display device, the above described method (3) for effecting the multi-color display may be used in combination. By this combination, it is possible to realize full-color display both in the transmission and reflection modes.

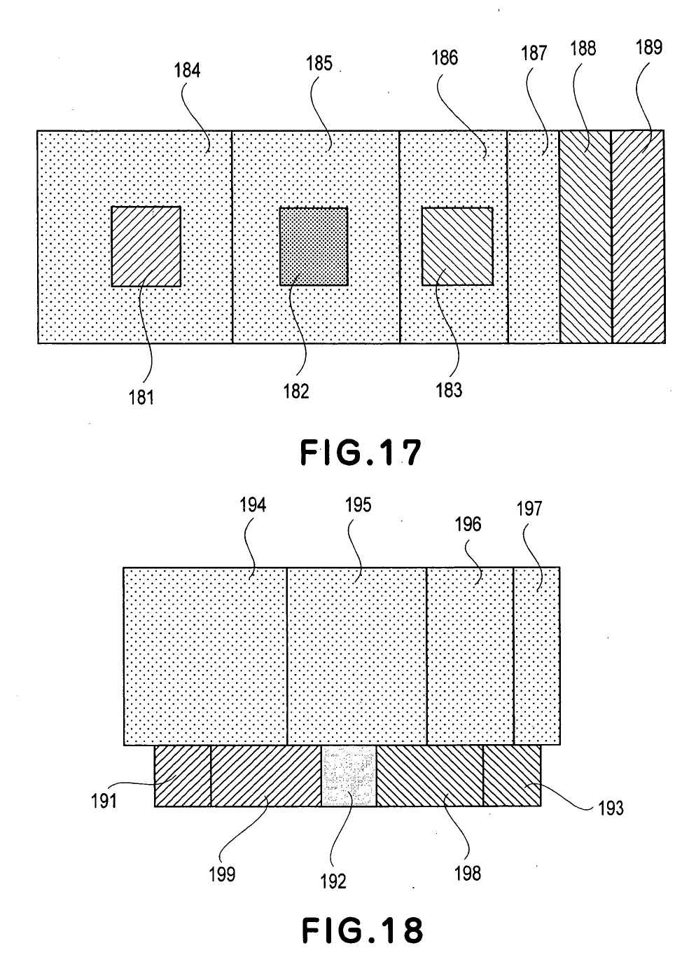

An example thereof is shown in FIG. 17, wherein one pixel unit is constituted by 9 pixels in total. Referring to FIG. 17, pixels 181, 182 and 183 are used for effecting transmission-type display and provided with color filters of red, green and blue, respectively. A pixel 185 is used for effecting reflection-type display and provided with a red color filter. Pixels 184, 186 and 187 are used for effecting reflection-type display and capable of effecting display of green and blue by the change in hue utilizing the ECB effect-based coloring phenomenon. These pixels 184, 186 and 187 are each provided with a color filter of color, complementary to red, such as cyan and are arranged at an areal ratio of 4:2:1. Further, pixels 188 and 189 are used for effecting reflection-type display and provided with a green color filter and a blue color filter, respectively. These pixels 188 and 189 have the same pixel area as that of the pixel 187.

As a result, with respect to display at the transmission-type subpixels, it is possible to effect full-color display by the color filters of red, green and blue at the subpixels 181, 182 and 183. With respect to display at the reflection-type subpixels, it is possible to effect full-color display by the pixel constitution of the subpixels 184 to 189. In addition, at the subpixels 184, 186 and 187, display of green and blue is effected by the change in hue utilizing the ECB effect-based coloring phenomenon, thus realizing bright full-color reflection display. As described above, by the constitution shown in FIG. 17, it is possible to realize full-color display both at the reflection and transmission subpixels. At the same time, due to the difference in color display mode between the reflection display and the transmission display, it is possible to have the advantage resulting from a remarkable reduction in thickness of the interlayer insulating film as described above.

The constitution shown in FIG. 17 may be changed to a constitution shown in FIG. 18.

In FIG. 18, subpixels 191, 192 and 193 for transmission-type display are provided with color filters of red, green and blue, respectively. A pixel 195 for reflection-type display is provided with a red color filter. Subpixels 194, 196 and 197 for reflection-type display are capable of effecting display of green and blue by the change in hue utilizing the ECB effect-based coloring phenomenon and provided with the color filter of color, complementary to red, such as cyan. These subpixels 194, 196 and 197 are arranged at an areal ratio of 4:2:1. Subpixels 198 and 199 for reflection-type display are provided with a green color filter and a blue color filter, respectively, and have the substantially same pixel area as that of the pixel 197. In this constitution, different from the constitution shown in FIG. 17, the subpixels provided with the green color filter and the blue color filter are disposed adjacent to each other, so that load on a fine patterning treatment of color filter can be advantageously reduced in the case where the green and blue color filters for reflection and transmission are used in common. Further, also in the case where the green and blue color filters are different in spectrum transmission characteristic between for reflection and for transmission, it is possible to minimize an influence on the display color when some deviation of alignment is caused to occur.

In each of the constitutions shown in FIGS. 17 and 18, nine subpixels in total may desirably be controlled independently so as to be supplied with an image information signal.

However, when the case where an environmental illuminance is low and the back light of the transflective-type liquid crystal display device of the present invention is turned on is taken into consideration, it is considered that image information on transmission-type pixel is predominant information as visually recognized image information of transmission-type pixel and that an area of the green and blue color filters used for reflection-type display is relatively small in the entire pixels. Accordingly, in FIG. 18, the pixels 191 and 199 as a blue pixel and the pixels 193 and 198 as a green pixel may be supplied with a common image signal.

By doing so, in the case of high environmental illuminance, the image information on reflection-type pixel becomes predominant, so that there is a possibility that a display quality is somewhat lowered. However, the green pixel and the blue pixel used in the reflection-type display inherently have a small areal ratio within one pixel, so that most of the image information is determined by the red color filter pixel and a pixel utilizing the change in hue on the basis of the ECB effect. Accordingly, it is considered that the display quality is not lowered so largely.

Further, in the case of high environmental illuminance, the back light is generally turned off, so that it is possible to effect display with no problem only by applying a desired data signal to the reflection-type pixel during the period in which the back light is turned off.

More specifically, in the case where a common signal as an image information (data) signal to be applied to the green pixel and the blue pixel is applied to the transmission area and the reflection area, a data is signal to be applied to the transmission area in predominantly applied when the back light is turned on, and a data signal to be applied to the reflection area is applied when the back light is turned off. As a result, it is possible to use a voltage application means in common with these pixels while minimizing a deterioration of display quality.

For example, in the case of driving the color display device having the constitution (one pixel unit) shown in FIG. 18 by using TFT, when all the pixels are independently driven, 9 TFT elements in total are required pixel by pixel with respect to one pixel unit. On the other hand, by employing the above described constitution in which the common data signal is applied, it is sufficient to dispose 7 TFT elements with respect to one pixel unit.

As described above, the color display device of the present invention can be used as the transmission-type display device and the reflection-type display device and can realize high light utilization efficiency. Further, the color display device of the present invention is also applicable to the transflective display device. In this case, in the reflection area, green and blue display principally utilizing the ECB-based coloring phenomenon in the present invention and red display with the color filter are effected and in the transmission area, color display with the color filter is effected with respect to red, green and blue. As a result, it is possible to realize display performances meeting all the requirements of the transflective liquid crystal display device. In addition, it is not necessary to provide the twice cell thickness difference within one pixel unit so that it becomes possible to compatibly satisfy simple process, uniform alignment, and high aperture ratio.

Incidentally, the color display device of the present invention can be driven by any of a direct drive method, a simple matrix drive method, and an active matrix drive method.

In the present invention, the substrate used may be formed of glass or plastics. In the case of the transmission-type display device, both the pair of substrates are required to be light transmissive. On the other hand, in the case of the reflection-type display device, as a supporting substrate, it is also possible to use a substrate through which light does not pass.

Further, the substrate used may have flexibility.

In the case of using the reflection-type display device, it is possible to employ various reflection plates, such as so-called front scattering plate comprising a scattering plate which is provided with a mirror reflection plate as a reflection plate and disposed outside the liquid crystal layer, or a so-called directional pixel plate having directivity by appropriately shaping a reflection surface.

In the above embodiments the vertical alignment (VA) mode is described as an example but the present invention is applicable to any mode, utilizing the change in retardation by voltage application, such as a homogeneous alignment mode, a HAN (hybrid aligned nematic) mode, or the OCB mode.

Further, in the above embodiments, such a normally black constitution that black display is effected at the time of no voltage application is described exemplarily. This normally black constitution can be realized by laminating a display layer, which does not assume birefringence in an in-plane direction of substrate under no voltage application, on a circular polarization plate. However, in the present invention, it is also possible to use such a normally white constitution that white display is effected at the time of no voltage application by replacing the circular polarization plate with an ordinary linear polarization plate. Alternatively, it is possible to use such a constitution that chromatic display is effected at the time of no voltage application by laminating a uniaxial phase-difference plate or the like on either one of the above constitutions. In this case, it is possible to display black or white by changing the alignment direction of liquid crystal molecules in such a direction that an amount of retardation of the laminated uniaxial phase-difference plate is cancelled by voltage application.

Further, in the present invention, it is also possible to adopt various alignment modes including such a liquid crystal mode as to provide a twisted alignment state as in the STN mode, and a guest-host mode.

In the above description, detailed explanation is made principally based on the ECB effect of the liquid crystal display device. However, a basic concept of the present invention is in that at a part of pixels, color display is effected by applying the color filter to the monochromatic display mode and in other pixels, a display mode capable of changing hue is utilized. Accordingly, in the present invention, other than the above described constitution using the ECB effect, it is possible to apply any display mode so long as the display modes described above are applicable to the color display device of the present invention.

For example, it is possible to apply the following modes (A) and (B):
(A) a mode in which a space distance of an interference layer is changed by mechanical modulation, and
(B) a mode in which colored particles are moved so as to switch a display state and a non-display state.

More specifically, the mode (A) is, e.g., a constitution as described at page 71 of SID 97 Digest, wherein a distance of a spacing between the interference layer and a substrate is changed to switch display and non-display modes of interference color. In this mode, ON/OFF switching is performed by external voltage control of a deformable aluminum film so that the film comes near to or away from the substrate. Further, a color development principle in this mode is based on utilization of interference, so that the same color development mechanism as the ECB effect-based interference described above is also employed.

Accordingly, also in the above spacing distance modulation device, it is possible to change an optical property by an externally controllable modulation means, such as a voltage, so that the device has a modulation area in which a brightness can be changed by the modulation means between a maximum brightness and a minimum brightness which are available by the device and a modulation area in which a plurality of hues which are available by the device can be changed. With respect to such a device, a unit pixel is divided into a plurality of pixels, and at least one of the plurality of pixels is constituted by a first subpixel at which color display using the hue change-based modulation area can be effected and a second subpixel provided with a color filter layer. As a result, similarly as in the liquid crystal display device described more specifically above, it is possible to realize a display device having an excellent characteristic such as a high light utilization efficiency.

In the (B) mode described above, e.g., a particle movement-type display device described in Japanese Laid-Open Patent Application No. Hei 11-202804 are suitably utilized. In the display device, switching between a display state and a non-display state is performed by applying a voltage between a collection electrode and a display electrode to move in parallel with a substrate surface on the basis of an electrophoretic characteristic.

It is also possible to modify the display device so as to have a constitution using two types of color particles. More specifically, the resultant display device has a unit cell constitution including: two display electrodes disposed at mutually overlapping positions when viewed from an observer's side; two collection electrodes; two types of charged particles which are different in charge polarity and color and include at least one type thereof being transparent; and a drive means capable of forming a state in which all the two types of charged particles are collected at the collection electrode, a state in which they are collected at the display electrode, a state in which one of the two types of charged particles are collected at the display electrode and the other type of charged particles are collected at the collection electrode; and an intermediary state of these states.

Such a constitution that the combination of the two types of charged particles in the unit cell is that of blue charged particles and green charged particles is considered. In this case, when white display is effected, it is sufficient to drive the display device so that all the blue and green charged particles are collected at the collection electrode to place the display electrode in an exposed state. Further, in the case of displaying a single color of green or blue, in the unit cell, only desired single-color particles are disposed on the display electrode to display the single color. On the other hand, in the case of driving black, in the unit cell, all the blue and green charged particles are disposed on the display electrode to form a light-absorbing layer, so that light enters each of the light-absorbing layers of green charged particles at a first display electrode and that of blue charged particles at a second display electrode, thus assuming black according to subtractive color mixture. In the case of halftone display, only a part of the particles at the time of displaying black are disposed on the display electrode. As a result, in the unit cell, it is possible to effect modulation of hue between the chromatic colors of green and blue and modulation of brightness by display of white, black and halftone.

Accordingly, by using such a constitution, the unit pixel is divided into a plurality of pixels including at least one of first subpixel capable of effecting color display by using the hue change-based modulation area and at least one second subpixel provided with the color filter layer. As a result, similarly as in the case of the liquid crystal display device described more specifically above, it is possible to realize a display device having an excellent characteristic. For example, in this constitution, it becomes possible to provide a particle movement-type display device which has a high display stability, particularly a high gradation display stability and is capable of effecting bright multi-color display.

Hereinbelow, the color display device according to the present invention will be described more specifically based on Examples.

### COMMON CONSTITUTION IN EXAMPLES

In the following Comparative Examples and Examples, a common device structure is as follows.

A basis constitution of a liquid crystal layer structure was the same as that shown in FIG. 4. More specifically, two glass substrates subjected to (homeotropic) vertical alignment treatment were applied to each other with a spacing to prepare a cell. Into the spacing of the cell, a liquid crystal material (Model: “MLC-2038”, mfd. by Merck & Co., Inc.) having a negative dielectric anisotropy (−Δ∈) was injected so that a cell thickness was changed to provide an optimum retardation in each example.

As the substrate structure used, one of the substrates was an active matrix substrate provided with thin film transistors (TFTs) and the other substrate was a color filter substrate provided with color filters.

A shape of pixels and a color filter constitution were changed appropriately depending on each example.

As a pixel electrode on the TFT side, an aluminum electrode was used to provide a reflection-type constitution. Incidentally, in some examples, a transflective-type constitution using a transmission-type pixel at which an ITO (indium-tin oxide) electrode was used as the pixel electrode on the TFT side.

Between an upper substrate (color filter substrate) and a polarization plate, a wide-band λ/4 plate (phase-compensation plate capable of substantially satisfying ¼ wavelength condition in visible light region) is disposed, thereby to provide such a normally black constitution that a dark state is given under no voltage application and a bright state is given under voltage application when reflection-type display is effected.

### Comparative Example 1

A liquid crystal panel was prepared by a conventionally known method. An active matrix substrate provided with TFTs and having pixels (600×800×3) in a diagonal size of 12 inches. More specifically, the pixels included 600 pixels in a column direction and 2400 pixels in a row direction, and a pitch of unit pixel was about 300 μm when 3 pixels in the row direction color-type of red, green and blue ordinarily used in TFT/LCD panel were provided at all the pixels.

With respect to a retardation of the liquid crystal layer, the cell thickness was adjusted to 1.8 pm so as to provide a center wavelength of 550 nm and a retardation of 138 nm for a reflection spectrum characteristic at the time of applying a voltage of ±5 V.

Incidentally, an about 1 degree of a pretilt angle from a normal to the substrate was given during vertical alignment treatment so that an inclination direction of liquid crystal molecules at the time of voltage application was 45 degrees in a clockwise direction at the entire liquid crystal layer surface when viewed from the polarization plate side above the panel.

When the thus prepared liquid crystal display device (Comparative Panel 1) was subjected to image display by variously changing the voltage, a continuous gradation color was obtained depending on the applied voltage each at the respective pixels of RGB, thus permitting full-color display.

However, a reflectance was 16%, thus resulting in dark display.

### Comparative Example 2

A liquid crystal panel was prepared in the substantially same manner as in the above described Patent Document 1 except that a single polarization plate constitution different from that of Patent Document 1 was employed as described above in view of a reflectance of the reflection-type liquid crystal display device.

### Comparative Example 2-1

As the color filters, only the red color filter was used. More specifically, in the row direction, the red color filter was formed so that red pixels and pixels with no color filter were alternately arranged.

At the red pixels, a cell thickness was 1.8 μm, and at the pixels with no color filter, the cell thickness was 4.7 μm (Comparative Panel 2) or 8 μm (Comparative Panel 3).

As a result, during red display, in any of the panels, it was possible to effect color display with a good color reproducibility on the basis of the color filter display. However, in Comparative Panel 2, green display was effected at the time of applying the voltage of 5 V but was not one with a good color reproducibility as described above. Further, in Comparative Panel 3, it was possible to effect green display with a good color reproducibility under application of the voltage of 5 V but it was difficult to prepare a uniform cell thickness panel since the cell thickness difference between the red pixels and the pixels other than the red pixels.

### Comparative Example 2-2

As the color filters, a yellow color filter and a cyan color filter were used. More specifically, in the row direction, the yellow and cyan color filters were formed so that yellow pixels and cyan pixels were alternately arranged.

The cell thickness both at the yellow pixels and the cyan pixels was 8 μm (Comparative Panel 4).

In Comparative Panel 4, it was possible to effect red display with a good color reproducibility but halftone red display could not be effected. Similarly, at the cyan pixels, it was possible to effect green display and blue display but halftone green display and halftone blue display could not be effected. Further, it was also not possible to effect a monochromatic halftone display.

### Example 1

As the active matrix substrate, the same substrate as in the above described Comparative Examples was used.

Only a red color filter was used as the color filters, and at remaining two color pixels, no color filter was used because of color display based on retardation. The remaining two color pixels were disposed at an areal ratio of 1:2 in order to effect area gradation.

With respect to a retardation of the liquid crystal layer, the cell thickness was adjusted to 4.7 μm so that an amount of retardation at the time of applying a voltage of ±5 V to a transparent pixel was 370 nm in order to effect green display and blue display.

When such a liquid crystal display device was subjected to image display by changing the voltage, at the pixels with the red color filter, it was confirmed that a change in transmittance depending on the applied voltage value was achieved to provide a complete continuous gradation characteristic.

On the other hand, at other pixels with no red color filter, green display was effected under application of 5 V and blue display was effected under application of 3.6 V, so that it was confirmed that the liquid crystal panel in this example was displayable with respect to three primary colors. Further, in a voltage range of not more than 2.5 V, it was confirmed that continuous gradation display depending on the applied voltage was effected.

In addition, with respect to red and blue, it was confirmed that area gradation could be realized by changing the number of pixels to be displayed. However, the number of gradation levels was 4, so that when a natural picture image was displayed, a resultant image was somewhat roughened.

Incidentally, the display device had a reflectance of 33%, thus being two times that in Comparative Example 1. As a result, bright white display on the basis of the single polarization plate method could be effected.

### Example 2

Two liquid crystal cells (display devices) were prepared in the same manner as in Example 1 except that as the active matrix substrate, a substrate having a diagonal length of 7 inches with pixels (600×800×3) arranged at a pixel pitch of about 180 μm and a substrate having a diagonal length of 3.5 inches with pixels (600×800×3) arranged at a pixel pitch of about 90 μm were used.

With respect to a color display ability of the liquid crystal display devices, it was confirmed that a good characteristic was obtained similarly as in Example 1. Further, in this example, the pixel pitch was decreased to have higher definition compared with those in Comparative Examples, so that it was possible to display continuous gradation such that there was substantially no roughened feeling by eyes even when a natural picture image was displayed.

Further, the reflectance of the display device was 33%, thus permitting considerably bright white display compared with Comparative Example 1.

### Example 3

A liquid crystal display device was prepared in the same manner as in Example 2 except that the same substrate as in Comparative Examples was used as the active matrix substrate and that the transparent pixels were changed to those having a pixel structure provided with a color filter (Model “CB-S570”, mfd. by FUJI FILM Arch Co., Ltd.) having a transmittance spectrum characteristic as shown in FIG. 6.

When the display device was supplied with a voltage at the pixels provided with the color filter of color complementary to red, similar as in Example 1, green display was effected at 5 V and blue display was effected at 3.6 V. As a result, it was confirmed that the liquid crystal panel of this example was displayable with respect to three primary colors. Further, it was also confirmed that in a voltage range of not more than 2.5 V, continuous gradation display of cyan could be effected depending on the applied voltage. Further, similarly as in Example 2, even when a natural picture image was displayed, it was possible to display continuous gradation such that there was substantially no roughened feeling by eye observation.

The reflectance of the display device was 28%, thus being somewhat lower than that in Example 2. However, considerably bright white display was still effected when compared with Comparative Examples. With respect to color display in this example, it was confirmed that a color reproduction range on the chromaticity coordination diagram was largely extended compared with that in Example 2.

### Example 4

In this example, odd-numbered row lines (scanning lines) constituting SVGA (800×600) pixels were formed of the aluminum electrode similarly as in Example 1. The subpixels included a subpixel provided with a red color filter and two subpixels which were provided with no color filter and were disposed at an areal ratio of 1:2.

On the other hand, even-numbered row lines were formed of the transparent electrode of ITO. The pixels along these row lines included a plurality of sets of three subpixels which had the same areal ratio and were provided with color filters of red, green and blue, respectively.

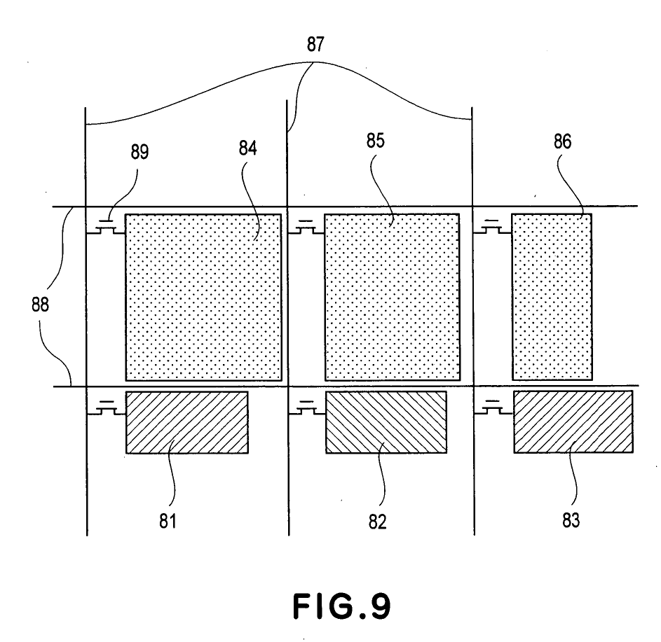

The pixel structure was shown in FIG. 9, wherein pixels 84, 85 and 86 were the odd-numbered reflection-mode pixels and pixels 81, 82 and 83 were the even-numbered transmission-mode pixels. Source lines 87 and gate lines 88 intersect with each other to form a plurality of pixels each provided with a switching element of TFT.

On the back side of the liquid crystal panel, another polarization plate was disposed to provide a cross-nicol relationship with the polarization plate disposed on the upper substrate. On the back side thereof, a back light was disposed and turned on.

When the thus constituted liquid crystal panel was subjected to image display, it was possible to confirm that the reflection-mode characteristic confirmed in the above described examples and the transmission-mode characteristic providing a display quality comparable to that of the ordinary liquid crystal panel could be compatibly realized. In other words, it was possible to confirm that a transflective-type liquid crystal display device capable of compatibly realizing the pixel mode having a high reflectance and the transmission mode having a good color reproducibility was realized even when the same cell thickness was set at all the pixels.

### Example 5

A liquid crystal display device was prepared in the same manner as in Example 4 except that the subpixels disposed at the areal ratio of 1:2 were provided with the cyan color filter having the spectrum characteristic shown in FIG. 6.

The display device could improved color purities of retardation of green and blue even in the reflection mode, thus realizing a transflective-type liquid crystal display device which had an extended color reproduction range.

### Example 6

A liquid crystal display device was prepared in the same manner as in Comparative Example 1 except that the SVGA mode (800×600 pixels) constituted by the plurality of sets each of three pixels was changed to a mode (600×600 pixels) constituted by a plurality of sets each of four pixels.

As the color filters, only a red color filter was used at one of each set of four pixels. At the remaining three pixels, color display based on retardation was utilized, so that no color filter was used. In order to effect area gradation, the three pixels were disposed at an areal ratio of 1:2:4.

With respect to the retardation of the liquid crystal layer, the cell thickness was adjusted to 4.7 μm so that an amount of retardation at the transparent pixels was 370 nm under application of the voltage of ±5 V in order to effect green display and blue display. A condition of the red pixels was the same as in Example 1.

When the thus constituted liquid crystal display device was subjected to image display by changing the voltage, with respect to the red pixels, a change in transmittance depending on the applied voltage value was achieved. As a result, it was confirmed that a complete continuous gradation characteristic was obtained.

On the other hand, with respect to other pixels provided with no color filter, green display was effected at 5. V and blue display was effected at 3.6 V, so that it was confirmed that the liquid crystal panel of this example was displayable with respect to three primary colors. Further, in a voltage range of not more than 2.5 V, it was confirmed that a bright (gradation) state was changed continuously depending on the magnitude of applied voltage.

With respect to green and blue, it was confirmed that it was possible to realize area gradation by changing the number of pixels to be displayed. A resultant gradation levels for green and blue was 8, so that it was possible to obtain an image with considerably alleviated roughened feeling compared with Example 1.

The reflectance of the display device was 33%, thus being two times that of the comparative examples. As a result, bright white display on the basis of the single polarization plate method could be effected.

### Example 7

Evaluation was made by using the same display device as in Example 6. More specifically, when the voltage applied to the pixels provided with no (red) color filter was continuously changed from 3 V to 5 V. As a result, a continuous change in color in the order of red (at about 3.0 V), magenta (at bout 3.2 V), blue (at about 3.6 V), cyan (at about 4.2 V), and green (at 5.0 V) was confirmed. Further, it was possible to confirm that under a voltage application condition for each of display colors, respective display colors could be displayed at 8 gradation levels.

### Example 8

A liquid crystal display device was prepared in the same manner as in Example 7 except that the transparent pixels were changed to those provided with a cyan color filter (Model “CM-B570”, mfd. by FUJIFILM Arch Co., Ltd.) similar to that used in Example 3. These cyan color filter pixels were disposed at an areal ratio of 1:2:4 in order to effect area gradation.

As a result, similarly as in Example 3, green display was effected at 5 V and blue display was effected at 3.6 V, so that it was confirmed that the liquid crystal panel of this example was displayable with respect to three primary colors. Further, in a voltage range of not more than 2.5 V, it was confirmed that it was possible to effect continuous gradation display of cyan depending on the magnitude of applied voltage.

According to this example, it was confirmed that an arbitrary display color on the arrows was displayed in the GB plane described above with reference to FIG. 14.

### Example 9

A liquid crystal display device was prepared in the same manner as in Example 8 except that the mode (600×600 pixels) constituted by the plurality of sets each of four pixels was changed to a mode (600×400 pixels) constituted by a plurality of sets each of six pixels.

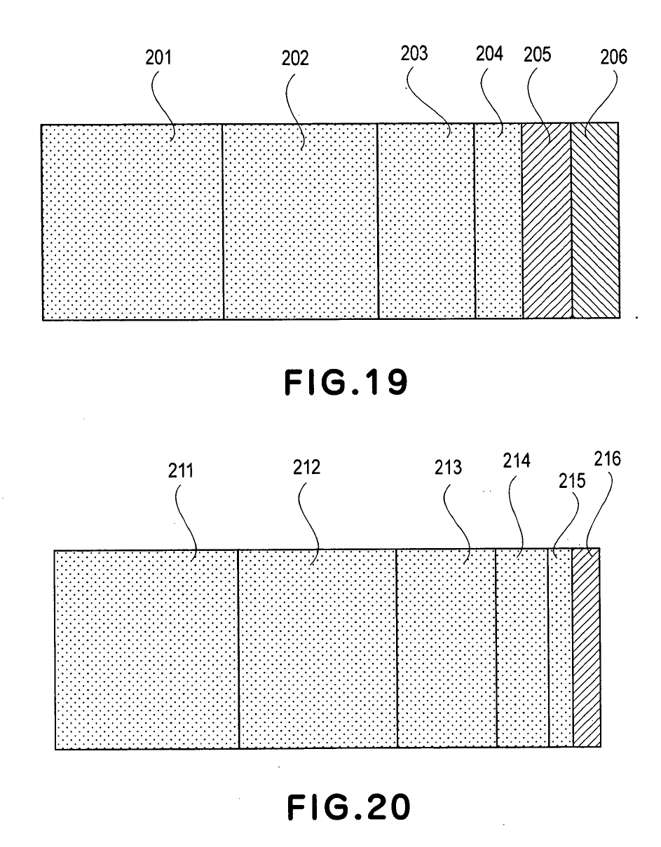

With respect to four of each set of pixels, a red color filter was used at one of the four pixels, and at three pixels, a color filter of cyan complementary to the color of the red color filter was used. These three pixels were pixel-divided at an areal ratio of 1:2:4. At the remaining two pixels, a green color filter and a blue color filter were provided, respectively. These green and blue color filter pixels had a size identical to that of a minimum pixel of the three cyan color filter pixels. The red color filter pixel had a size which was 1.3 of the total area of the six pixels. A resultant pixel structure is shown in FIG. 19, wherein a red color filter pixel 202; area-divided three cyan color filter pixels 201, 203 and 204; a green color filter pixel 205, and a blue color filter pixel 206 are shown.

By using this constitution, it was confirmed that it was possible to effect display of gradation including continuous gradation of cyan in the voltage range of not more than 2.5 V, 8 gradation levels of green and blue by a combination of the ECB-based coloring phenomenon and the area division, and green and blue continuous gradation for complementing the 8 gradation levels. Further, in combination of these gradation display methods, it was confirmed that display of all the displayable colors in the GB plane was possible. Further, by combining these gradation display methods with the continuous gradation display of red, it was possible to confirm realization of complete full-color display.

The reflectance of the display device was 25% which was somewhat inferior to that in Example 6. However, compared with the comparative examples, considerably bright white display was effected. Further, also in color display of this example, it was possible to confirm that the color reproduction range on the chromaticity coordination diagram was largely extended by the effect of cyan color filter when compared with Example 2.

Further, the very small green pixels had a continuous gradation characteristic, so that it was possible to confirm that the number of displayable gradation levels compared with the conventional liquid crystal display device prepared in Comparative Example 1. As a result, the number of gradation levels of green having a high viewability was remarkably increased, so that it became possible to effect natural image display which had not been conventionally realized.

### Example 10

A liquid crystal display device was prepared in the same manner as in Example 9 except that the mode (600×400 pixels) constituted by the plurality of sets each of six pixels was changed to a mode (450×400 pixels) constituted by a plurality of sets each of eight pixels.

At three pixels of each of sets of eight pixels, similarly as in Example 9, the green color filter, the red color filter, and the blue color filter were provided, respectively. At the remaining five pixels, a color filter of cyan complementary to the color of the red color filter was provided. These five pixels were pixel-divided at an areal ratio of 1:2:4:8:16. The green and blue color filter pixels had a size identical to that of a minimum pixel of the five cyan color filter pixels. The red color filter pixel had a size which was 1.3 of the total area of the eight pixels.

By using this constitution, it was confirmed that it was possible to effect display of gradation including continuous gradation of cyan in the voltage range of not more than 2.5 V, 32 gradation levels of green and blue by a combination of the ECB-based coloring phenomenon and the area division, and green and blue continuous gradation for complementing the 32 gradation levels. Further, in combination of these gradation display methods, it was confirmed that display of all the displayable colors in the GB plane was possible. Further, by combining these gradation display methods with the continuous gradation display of red, it was possible to confirm realization of complete full-color display.

The reflectance of the display device was 27% which was somewhat inferior to that in Example 6. However, compared with the comparative examples, considerably bright white display was effected. Further, by relatively reducing the sizes of the green color filter and the blue color filter, it was possible to confirm that the color light loss was suppressed at a minimum level.

### Example 11

A liquid crystal display device was prepared in the same manner as in Example 10 at the mode (600×400 pixels) constituted by a plurality of sets each of six pixels.

With respect to five of each set of pixels, a red color filter was used at one of the four pixels, and at four pixels, a color filter of cyan complementary to the color of the red color filter was used. These four pixels were pixel-divided at an areal ratio of 1:2:4. At the remaining one pixel, a green color filter was provided. The green color filter pixel had a size identical to that of a minimum pixel of the four cyan color filter pixels. The red color filter pixel had a size which was 1.3 of the total area of the six pixels. A resultant pixel structure is shown in FIG. 20, wherein a red color filter pixel 202; area-divided three cyan color filter pixels 211, 213, 214 and 215; and a green color filter pixel 216 are shown.

By using this constitution, it was confirmed that it was possible to effect display of gradation including continuous gradation of cyan in the voltage range of not more than 2.5 V, 16 gradation levels of green and blue by a combination of the ECB-based coloring phenomenon and the area division, and green and blue continuous gradation for complementing the 16 gradation levels. Further, in combination of these gradation display methods, it was confirmed that display of all the displayable colors in the GB plane was possible. Further, by combining these gradation display methods with the continuous gradation display of red, it was possible to confirm realization of complete full-color display.

The reflectance of the display device was 27% which was somewhat inferior to that in Example 6. However, compared with the comparative examples, considerably bright white display was effected. Further, also in color display of this example, it was possible to confirm that the color reproduction range on the chromaticity coordination diagram was largely extended by the effect of cyan color filter when compared with Example 2.

### Example 12

By using the display device prepared in Example 11, display was effected by deviating the black reference position according to the above described method shown in FIG. 15. As a result, although a resultant contrast was somewhat lowered, the reflectance of white was comparable to that in Example 11 and it was possible to confirm that full-color display could be effected.

### Example 13

A liquid crystal display device was prepared in the same manner as in Example 12 except that the mode (600×400 pixels) constituted by a plurality of sets each of six pixels was changed to a mode (600×400 pixels) constituted by a plurality of sets each of nine pixels as shown in FIG. 18 described above. The cell thickness was uniformly set to 4.7 μm at all the pixels. Six pixels of the nine pixels were provided with aluminum reflection electrode. A pixel structure was the same as in Example 11. The remaining three pixels of the nine pixels were transparent pixels provided with the ITO electrodes disposed on both of the pair of substrates.

On the back side of the liquid crystal panel, another polarization plate was disposed in a cross-nicol relationship with the polarization plate disposed on the upper substrate. On the back side thereof, a back light was disposed and turned on.

When the thus constituted liquid crystal panel was subjected to image display by applying independently a desired voltage to the respective pixels, it was possible to confirm that the reflection-mode characteristic confirmed in the above described examples and the transmission-mode characteristic providing a display quality comparable to that of the ordinary liquid crystal panel could be compatibly realized.

As a result, even when the same cell thickness was set at all the pixels, it was possible to confirm realization of a transflective-type liquid crystal display device which was capable of compatibly providing the full-color reflection mode having a high reflectance and the transmission mode having a good color reproducibility.

### Example 14

Evaluation was made by using the same liquid crystal display device as in Example 13, wherein an identical voltage was applied to the pixels 13, wherein an identical voltage was applied to the pixels 181 and 189 described with reference to FIG. 17 and an identical voltage was applied to the pixels 183 and 188. Further, image evaluation in places different in environmental illuminance was performed under an optimum image data (information) signal voltage application condition for the reflection-type display (C(R)) and an optimum image data signal voltage application condition for the transmission-type display (C(T)).

When image display was effected in a dark place while turning on the back light, an image to be inherently displayed could not be obtained under the condition C(R) but a desired image was obtained under the condition C(T).

Then, when the back light was turned off in the dark place, the resultant images were dark under both of the C(R) and C(T) conditions. As a result, it was impossible to evaluate the images.

Next, when the image display was effected in an outdoor bright place while turning on the back light, a desired image was displayed under the condition C(R). Under the condition C(T), a substantially desired image was displayed although there was a delicate informity.

Thereafter, when the image display was effected after the back light was turned off in the outdoor bright place, a desired image was displayed under the condition C(R). Under the condition C(T), a substantially desired image was displayed although there was a delicate inconformity.

According to this example, it was possible to confirm that the image display was generally effected under the voltage application condition C(T) at the time of turning on the back light although there was the delicate inconformity and under the voltage application condition C(T) at the time of turning off the back light. Further, in the bright place, the back light was generally turned on, so that when the back light was set to be turned off in the bright state, it was possible to confirm that a desired image could be always obtained.

Further, as described above, a practically sufficient characteristic was obtained when the pixels 181 and 189 were supplied with the identical voltage and the pixels 183 and 188 were supplied with the identical voltage, so that in the above described constitution, it was possible to confirm that the number of necessary TFTs was described from 9 to 7 per pixel.

As described hereinabove, according to the above mentioned Examples 1 to 14, it becomes possible to realize the bright reflection-type liquid crystal display device and the bright transflective-type liquid crystal display device. Incidentally, in these examples, the reflection- and transflective-type liquid crystal display devices of direct view-type are described but the constitutions thereof are applicable to a transmission-type liquid crystal display device of direct view-type, a projection-type liquid crystal display device, a liquid crystal display device provided with a view finder using a magnifying optical system, and so on. Further, in the above examples, the TFT is used in the drive substrate. However, instead of the TFT, it is possible to use MIM (metal-insulator-metal) or such a substrate constitution that a switching element is formed on a semiconductor substrate. It is also possible to change the active matrix drive method to the single matrix drive method or a plasma addressing drive method.

Further, in the above examples, the vertical alignment mode is principally described but the constitutions of the present invention are applicable to any mode so long as it is a mode, utilizing a change in retardation under voltage application, such as the homogeneous alignment mode, the HAN mode, the OCB mode, or the like. It is also possible to apply the above described liquid crystal alignment mode to such an alignment mode in which liquid crystal molecules are placed in a twisted alignment state as in the STN mode.

Further, similar effects as in the above described examples are achieved even by using such a mode as to change a spacing distance of interference layer by mechanical modulation in place of the liquid crystal display device having the ECB effect. Further, it is also possible to attain the above described effects similarly as in the examples even when the particle movement-type display device having the above described constitution is employed.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 134765/2004 filed Apr. 28, 2004, which is hereby incorporated by reference.

1. A color display device of the type wherein a display unit is constituted by a plurality of pixels each comprising a first subpixel and a second subpixel, and at each subpixel, a medium for changing an optical property depending on an externally applied voltage is provided,
wherein at the second subpixel, a red color filter is disposed,
wherein the medium changes the optical property within a brightness-changing voltage range in which light passing through the medium changes brightness while assuming achromatic color and a hue-changing voltage range in which the light passing through the medium assumes chromatic color and changes hue of the chromatic color, and
wherein a voltage in the hue-changing voltage range is applied to at least a part of the first subpixel, and a voltage in the brightness-changing voltage range is applied to the second subpixel, thereby to effect color display on a display unit basis.

2. A device according to claim 1, wherein to the first subpixel, a voltage at which the light passing through the medium assumes blue, green, and their intermediary chromatic color is applied.

3. A device according to claim 1, wherein the first subpixel is provided with a color filter of a color complementary to the color of the red color filter, and a voltage in the hue-changing voltage range is applied to the first subpixel to display a color obtained by color mixing of the chromatic color with the color complementary to the color of the color filter.

4. A color display device of-the type comprising: at least one polarization plate; a pair of substrates provided with oppositely disposed electrodes; and a liquid crystal layer, disposed between the substrates, for changing a retardation depending on a voltage applied between the electrodes, wherein a display unit is constituted by a plurality of pixels each comprising a first subpixel and a second subpixel;
wherein at the second subpixel, a red color filter is disposed,
wherein the liquid crystal changes the optical property within a brightness-changing voltage range in which light passing through the liquid crystal changes brightness while assuming achromatic color and a hue-changing voltage range in which the light passing through the medium assumes chromatic color and changes hue of the chromatic color, and
wherein a voltage in the hue-changing voltage range is applied to at least a part of the first subpixel, and a voltage in the brightness-changing voltage range is applied to the second subpixel, thereby to effect color display on a display unit basis.

5. A device according to claim 4, wherein the first subpixel is provided with a color filter of a color complementary to the color of the red color filter, and a voltage in the hue-changing voltage range is applied to the first subpixel to display a color obtained by color mixing of the chromatic color with the color complementary to red.

6. A device according to claim 5, wherein to the first subpixel, a voltage providing a retardation of approximately 750 nm is applied, thus effecting display of green.
